(19) United States
(12) Patent Application Publication
(10) Pub. No.: US 2010/0121752 A1
(43) Pub. Date: May 13, 2010

(54) Web-Based Bid Analysis, Award, and Contract Management System

(76) Inventors: Michael H. Banigan, Frisco, TX (US); Phillip Ayoung-Chee, Boca Raton, FL (US); Todd Bennett, Boca Raton, FL (US); Joseph Clancy, Boynton Beach, FL (US); Norman Zwiebel, Delray Beach, FL (US); Wanda Zwiebel, Delray Beach, FL (US)

Correspondence Address: CARSTENS & CAHOON, LLP, P O BOX 802334, DALLAS, TX, 75380, US

(21) Appl. No.: 12/269,780

(22) Filed: Nov. 12, 2008

(51) Int. Cl. G06Q 40/00

(52) U.S. Cl. 705/37

(57) ABSTRACT

A Web-based system for use in analyzing and awarding bids for pharmaceuticals, hospital and other medical or surgical center supplies and for managing the underlying contracts. The system features a bid management utility, a drug catalog and sales data utility, and a contract management utility. Each utility is accessible by a user based upon user privileges. The drug catalog allows user lookup of contracted drugs. The bid management utility allow a GPO to create a RFP. When the RFP is complete, it is sent via the system to participating vendors for bidding. Once a contract is established, the system database allows modification of certain contract details.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL, SUBMITTED ON A COMPACT DISC

Not Applicable

### BACKGROUND OF THE INVENTION

1. Field of the Invention

The present invention relates to a Web-based system for accepting and awarding bids for purchase of goods, and management of the purchase contracts, and, more specifically, to a Web-based system for use in analyzing and awarding bids for purchase of pharmaceuticals, hospital supplies, and other medical or surgical center supplies and for managing the underlying contracts related to the purchase.

2. Description of Related Art Including Information Disclosed Under 37 CFR 1.97 and 1.98

Healthcare organizations, such as hospitals, typically require substantial amounts of pharmaceuticals and supplies. Although the amounts tend to be large, the volume is rarely large enough to command competitive pricing by vendors. To obtain preferential pricing on pharmaceuticals and supplies, individual healthcare organizations often join group purchasing organizations (GPO) to leverage the GPO's purchasing clout.

A GPO is an entity that represents multiple purchasers. The GPO negotiates contracts on behalf of its members using the combined members' purchasing power to obtain advantageous pricing. Once contracts are negotiated, the individual members do their own purchasing, using the pricing originally negotiated by the GPO.

Traditionally, a GPO combines the individual requests of each healthcare organization member and generates a request for proposal (RFP) in a spreadsheet program. Spreadsheets (such as Microsoft Excel) are favored due to the complexity of the calculations involved with the request. Substantial complexity is involved because each RFP typically contain requests for hundreds of items, with each item having sophisticated pricing calculations.

GPOs often maintain a drug formulary to assist in RFP creation. A drug formulary which is a list of drugs it has approved for purchase and use by members. This formulary is typically created by manual data entry based on drug information obtained from the FDA Orange Book or the Drugs@FDA database. This alone can be quite difficult given that there are, at present, approximately 5,800 drug names—each having varying dosages and packaging. Part of the RFP consists of the entry of drug data taken from the formulary such as name, packaging dose, manufacturer, etc. This increases the probability for additional RFP data entry errors.

Once completed, the RFP is submitted to numerous vendors of the particular requested goods. The vendors then respond with individualized bids to fulfill the requested order. The GPO then considers the bids against some criteria and selects the best possible deal for its members. This entire process is fraught with the potential for errors that may translate into significant losses in revenue for a vendor or substantial overpayment by a GPO for particular goods.

Tracking each of the recipients of the RFP becomes exceedingly difficult given that each vendor may be in a different stage of bid analysis at any given time. In addition, tracking the number of bids submitted by vendors to answer the RFP exacerbates the problem. GPOs often pass the RFP spreadsheets to vendors, allowing multiple parties to make entries on the same spreadsheet. Significant errors may be introduced into the process in this fashion.

Further, the generation of new RFPs by a GPO often requires review and auditing of previous transactions. Errors from the previous RFP can be easily transmitted to the current RFP. Errors may also be introduced by the individual importing the data into the new RFP.

Accordingly, a need exists for a system and method for automating the bid analysis, bid award, and contract management process related to pharmaceuticals and medical supplies that eliminates or reduce's the potential for introduction of human errors into the process. Further, a need exists for such a system to retain data for auditing and managing the entire bid analysis/award and contract management process.

### BRIEF SUMMARY OF THE INVENTION

The present invention is a network based pharmaceutical goods bid analysis, bid award, and contract management method, computer software, and system or performing the method using the computer software. The invention is accessed by users belonging to predefined classes such as purchaser and supplier. Multiple users may access the system simultaneously via web or specialized user interfaces.

The method, computer program, and system provide a user interface. The interface presents the user with functionality specific to the user's class. From the interface the purchasing user creates an RFP consisting of at least one good. In response, the supplier user submits a bid via the interface to the purchaser user. The purchaser user may then review the bid via the interface and either accept or reject the user's bid. Upon acceptance, the purchaser user creates a purchasing contract with the supplier user of the respective bid. The RFP, bid, and resulting awards contract may each be managed using the same interface with management functionality determined by the user's class.

The method, computer program, and system also provides a searchable drug catalog and formulary for access during RFP creation and management. The drug catalog is automatically updated and maintained current using the National Drug Code directory. The Formulary is updated by acceptance of the user's usage or previous contract data.

To assist in awarding bids, the bids may be automatically ranked by user assigned penalties. The penalties applied consist of one or more of the following: WAC Discount, Fixed or Non-Fixed Pricing, Admin Fee Rebate, and Market Fee Rebate. This penalty is applied to each of the purchaser user's bids and displayed in the interface for comparison. The purchaser user may also allow the system to automatically accept the highest ranking bids. When a bid is awarded, the system generates an automatic notification to the supplier of the bid. This notification is by an automatically generated email, letter, or both.

All contracts entered into by a user may be managed from within the system. Also, contracts entered without the system may be managed from within the system by uploading the contract data. Contract data is maintained in a central location for access by all concerned parties.

These and other improvements will become apparent when the following detailed disclosure is read in light of the supplied drawings. This summary is not intended to limit the scope of the invention to any particular described embodiment or feature. It is merely intended to briefly describe some of the key features to allow a reader to quickly ascertain the subject matter of this disclosure. The scope of the invention is defined solely by the claims when read in light of the detailed disclosure.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 is an illustration of a high-level overview of an embodiment of the system of the present invention.

FIG. 2 is a flow diagram depicting high-level steps taken during a transaction by users of an embodiment of the system of the present invention;

FIG. 3 is a flow diagram depicting certain functions available to a GPO when using an embodiment of the system of the present invention to prepare an RFP;

FIG. 4 is a flow diagram depicting certain functions available to a GPO when reviewing a bid received from a vendor when using an embodiment of the system of the present invention;

FIG. 5 is a flow diagram depicting certain functions available to a GPO when awarding or rejection a vendor's bid when using an embodiment of the system of the present invention;

FIG. 6 is a flow diagram depicting certain functioning available to a vendor when preparing a bid to a received RFP when using an embodiment of the system of the present invention;

FIG. 7 is a flow diagram depicting certain functions available to a vendor when completing and submitting a bid to a received RFP when using an embodiment of the system of the present invention;

FIG. 8 is a flow diagram depicting certain functions available to a GPO when using the drug catalog feature of an embodiment of the present invention;

FIG. 9 is a flow diagram depicting certain functions available to a GPO for managing awarded contracts;

FIG. 10 is an illustration of a graphical user interface (“GUI”) that allows a GPO to view and manipulate contract data on a vendor-by-vendor basis;

FIG. 11 is an illustration of a GUI that allows a GPO to view and manipulate contract data on an item-by-item basis;

FIG. 12 is an illustration of the main GUI for accessing the system by a GPO in an embodiment of the present invention;

FIG. 13 is an illustration of a GUI for accessing the system by a vendor in an embodiment of the present invention;

FIG. 14 is an illustration of a GUI of an embodiment of the present invention as used by a GPO to manage existing RFPs;

FIG. 15 is an illustration of a GUI of an embodiment of the present invention as used by a GPO to create a new RFP;

FIG. 16A is an illustration of a GUI of an embodiment of the present invention as used by a GPO to configure an RFP showing the ability to manipulate the RFP dates;

FIG. 16B is an illustration of a GUI of an embodiment of the present invention as used by a GPO to configure an RFP, showing the ability to set RFP options;

FIG. 16C is an illustration of a GUI of an embodiment of the present invention as used by a GPO to configure an RFP, showing the ability to manipulate RFP fee data;

FIG. 16D is an illustration of a GUI of an embodiment of the present invention as used by a GPO to configure an RFP, showing the ability to manipulate permissions associated with the RFP;

FIG. 17 is an illustration of a GUI of an embodiment or the present invention as used by a GPO to establish trade classes associated with particular RFPs;

FIG. 18 is an illustration of a GUI of an embodiment of the present invention as used by a GPO to access the GPO's formulary to add items to the RFP for purchase;

FIG. 19 is an illustration of a GUI of an embodiment of the present invention as used by a GPO to manipulate the formulary, showing the ability of the system to accept usage data document uploads;

FIG. 20 is an illustration of a GUI of an embodiment of the present invention as used by a GPO to manipulate the formulary, showing the interface for updating the formulary based on items added to the RFP;

FIG. 21 is an illustration of a GUI of an embodiment of the present invention as used by a GPO to manipulate the formulary, showing the interface for uploading existing contract data documents associated with particular trade classes;

FIG. 22 is an illustration of a GUI of an embodiment of the present invention as used by a GPO to specify formulary items within the REP framework;

FIG. 23 is an illustration of a GUI of an embodiment of the present invention as used by a GPO to manage the list of vendors associated with the RFP;

FIG. 24 is an illustration of a GUI of an embodiment of the present invention as used by a GPO to manage the appropriate vendor contacts associated with the RFP;

FIG. 25 is an illustration of a GUI of an embodiment of the present invention as used by a GPO to upload documents associated with the RFP to be transmitted to the vendors in conjunction with the RFP;

FIG. 26 is an illustration of a GUI of an embodiment of the present invention as used by a GPO to generate REP notification letters to each assigned vendor;

FIG. 27 is an illustration of a GUI of an embodiment of the present invention as used by a GPO to generate RFP notification email messages to each assigned vendor;

FIG. 28 is an illustration of a notification letter of an embodiment of the present invention soliciting a bid from a vendor for a completed RFP;

FIG. 29 is an illustration of a GUI of an embodiment of the present invention as used by a GPO to view the status of all bids from the associated vendors;

FIG. 30 is an illustration of a GUI of an embodiment of the present invention as used by a GPO to view further detail of the status of a bid from a single associated vendor;

FIG. 31 is an illustration of a GUI of an embodiment of the present invention as used by a GPO to establish penalties for various aspects of the bids to automatically assist the GPO in ranking each bid;

FIG. 32A is an illustration of a GUI of an embodiment of the present invention as used by a GPO to search the received bids for generation of reports;

FIG. 32B is an illustration of a GUI of an embodiment of the present invention as used by a GPO to review each bid returned during generation of reports;

FIG. 33 is an illustration of a GUI of an embodiment of the present invention as used by a GPO to generate reports based on the received bids to assist in bid analysis and auditing;

FIG. 34 is an illustration of a GUI of an embodiment of the present invention as used by a GPO to assign contract numbers and fees to awarded bid contracts;

FIG. 35A is an illustration of a GUI of an embodiment of the present invention as used by a GPO to establish awarded bid contract details for a specific vendor, with the GUI split between FIG. 35A and FIG. 35B;

FIG. 35B is an illustration of a GUI of an embodiment of the present invention as used by a GPO to establish awarded bid contract details for a specific vendor, with the GUI split between FIG. 35A and FIG. 35B;

FIG. 35C is an illustration of a GUI of an embodiment of the present invention as used by a GPO to show details of a particular drug whose NDC was selected from the GUI in FIG. 35B;

FIG. 36 is an illustration of a GUI of an embodiment of the present invention as used by a GPO to generate and submit email messages to each assigned vendor, notifying same of the existence of a relevant awarded bid contract;

FIG. 37 is an illustration of a GUI of an embodiment of the present invention as used by a vendor to select a received RFP;

FIG. 38 is an illustration of a GUI of an embodiment of the present invention as used by a vendor to view any external documents uploaded by the GPO and associated with the RFP;

FIG. 39 is an illustration of a GUI of an embodiment of the present invention as used by a vendor to manipulate unique vendor-specific Labeler IDs associated with pharmaceuticals listed in the National Drug Data File (“NDDF”);

FIG. 40 is an illustration of a GUI of an embodiment of the present invention as used by a vendor to view or edit contact information associated with the RFP;

FIG. 41A is an illustration of a GUI of an embodiment of the present invention as used by a vendor to manage common bid proposals;

FIG. 41B is an illustration of a GUI of an embodiment of the present invention as used by a vendor to select criteria to use in managing common bid proposals;

FIG. 42A is an illustration of a GUI of an embodiment of the present invention as used by a vendor to establish specific bid pricing;

FIG. 42B is an illustration of a GUI of an embodiment of the present invention as used by a vendor to view and manipulate the pricing of a specific requested pharmaceutical selected from the GUI of FIG. 42A;

FIG. 43 is an illustration of a GUI of an embodiment of the present invention as used by a vendor to locate or add items to the system's drug database;

FIG. 44 is an illustration of a GUI of an embodiment of the present invention as used by a vendor to upload bid related documents and contract notes for viewing by the GPO;

FIG. 45 is an illustration of a GUI of an embodiment of the present invention as used by a vendor to generate reports based on the vendor's responses to the RFP;

FIG. 46 is an illustration of a GUI of an embodiment of the present invention as used by a vendor to submit the bid proposal to the GPO;

FIG. 47 is an illustration of a GUI of an embodiment of the present invention as used by a vendor to view awarded bid contracts and to view award reports;

FIG. 48 is an illustration of a GUI of an embodiment of the present invention as used by a GPO to access the system's drug catalog to view the pharmaceuticals supplied by a given vendor;

FIG. 49 is an illustration of a GUI of an embodiment of the present invention as used by a GPO to access the system's drug catalog to view the entries by searching by drug name;

FIG. 50 is an illustration of a GUI of an embodiment of the present invention as used by a GPO to access the system's drug catalog to view the entries by searching for a particular National Drug Code (“NDC”);

FIG. 51 is an illustration of a GUI of an embodiment of the present invention as used by a GPO to access the system's drug catalog to view the entries by searching by searching by the American Hospital Formulary Service (“AHFS”) code or description;

FIG. 52 is an illustration of a GUI of an embodiment of the present invention as used by a GPO to view products currently on contract with a given vendor;

FIG. 53A is an illustration of a GUI of an embodiment of the present invention as used by a GPO to view drug-specific data in more detail than provided by the GUI of FIG. 52;

FIG. 53B is an illustration of a GUI of an embodiment of the present invention as used by a GPO to view current or historical pricing for the drug currently on contract with the given vendor as highlighted in the GUI of FIG. 53A;

FIG. 53C is an illustration of a GUI of an embodiment of the present invention as used by a GPO to view AHFS equivalents for the drug currently on contract with the given vendor as highlighted in the GUI of FIG. 53A;

FIG. 53D is an illustration of a GUI of an embodiment of the present invention as used by a GPO to view generic equivalents for the drug currently on contract with the given vendor as highlighted in the GUI of FIG. 53A;

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood. (58,266).

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Initial Definitions and Acronyms as Used Herein:
Wholesaler Acquisition Cost (“WAC”)—An amount set by a vendor that determines the price a wholesaler will pay for a drug. This is also referred to as the National Wholesaler Price (“NWP”);
Wholesaler Acquisition Cost Discount (“WAC Disc.”)—A discount based on the WAC price that is available to all GPO members that is buying a particular drug. The discount amount is negotiated between the GPO and vendor during bidding;
National Drug Code (“NDC”)—The National Drug Code (NDC) is the unique ten-digit numeric code assigned to a drug product by the Food and Drug Administration (FDA) and the manufacturer or distributor. The NDC identities the manufacturer/distributor, drug, dosage form, strength, and package size; and
American Hospital Formulary Service Code (“AHFS”)—The AHFS Code Identifies the pharmacologic therapeutic category of the drug product according to the American Hospital Formulary Service classification system. This code is also known as the “Therapeutic Class” of a drug product.

The system of the present invention is typically accessed by two classes of users: purchasers and suppliers. However, other classes may be determined and are within the scope of the invention. For example, an administrator class may be available to administer the overall system (i.e., user access controls, user registration, database administration, etc.). The administrator class may be further divided into subclasses such as database administrator, user administrator, system auditor, and the like. The type of functionality available to the user is dependent upon the class, and is controlled by access privileges.

The purchaser class is represented herein by the GPO. The GPO typically represents multiple purchasing members (108). However, the system may also be accessed directly by a sole purchaser. For example, a particular hospital may purchase in sufficient quantities such that it need not join a GPO to obtain pricing benefits. In this instance, the hospital may access the system in the same manner as a GPO. Thus, references to a GPO herein include all individuals or entities seeking proposals for the purchase of pharmaceuticals and hospital or surgery center supplies.

The supplier class is represented herein by the vendor. Further, references herein to vendors include pharmaceutical manufacturers, distributors, and any individual or entity involved in supply of pharmaceuticals that wishes to submit bids to proposal requests.

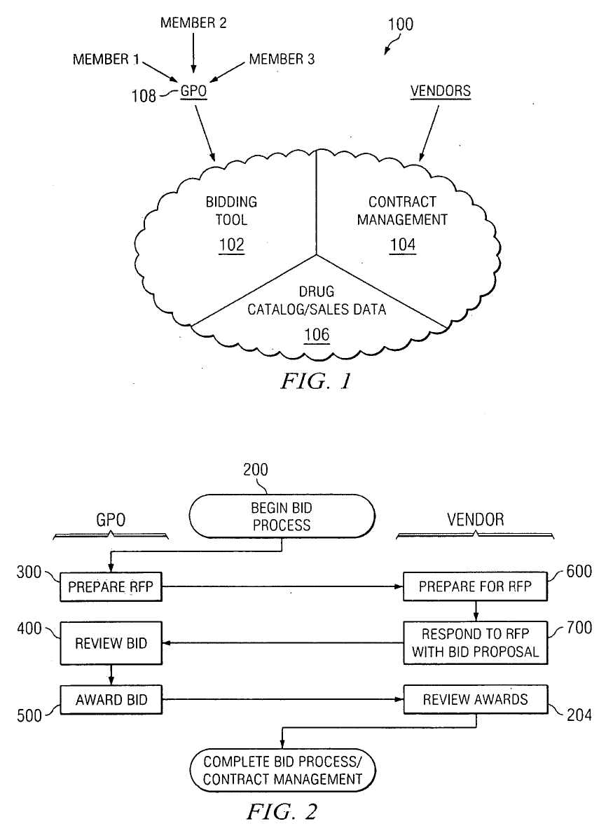

In the preferred embodiment as depicted in FIG. 1, the present invention combines a bidding tool (102), a contract management tool (104) and a drug catalog with sales data (106) to assist in requesting and awarding bids for pharmaceuticals and management of the resulting contracts utilizing a common Web interface. While the following disclosure exclusively discusses pharmaceuticals, one skilled in the art will appreciate that the system and corresponding methods apply equally to bid proposal/award and management of resulting contracts related to non-pharmaceutical hospital or surgery center supplies. Such non-pharmaceutical goods are within the scope of the present invention. Reference herein to goods is intended to include pharmaceutical goods and all non-pharmaceutical goods utilized by a hospital, surgical center, or other medical care provider.

The present system utilizes one or more computing processors running specialized computing code to provide the disclosed functionality. The computer processors may be any general or special purpose computer having network capabilities. The processors may be connected to a public or private network and/or the Internet such that they are accessible by the GPO and vendor. Access to the system may be over the network through a general Web browser or a special purpose GUI. One or more databases are also provided to store and maintain access to all transactional and drug catalog data.

As used herein, the term “network” is intended to include all LAN and WAN private and public network configurations, including intranets and the Internet. Such networks include all wired and wireless configurations. Further, as used herein the term “interface” is intended to include an interface designed to display and function in a common Internet browser (such as Internet Explorer, Firefox, and the like) or dedicated program GUI having network capabilities.

The specialized computing code used to provide the display and functionality may be any software language (such as XML, Java, C++, or the like) that is operable on the base hardware processor. Further, such software languages may be combined such that various portions of the system may be programmed utilizing different software components.

The preferred embodiment features a database within which all system data is maintained and accessed. This database may be separate from the Web server used to connect the system to the Internet, or it may be integral in the same computing platform. Further, multiple databases may be provided to isolate the transactional data from the drug catalog data, or may even be used to further isolate and/or fragment the transactional data to provide redundancy and improved fault tolerance.

FIG. 2 is a flow diagram of the progression of a typical RFP/bid cycle utilizing the system of the present embodiment. Users of the system must first register and obtain a Login and Password. A GPO first logs into the system to begin the RFP/bid process (200). The GPO prepares an RFP (300). The RFP contains details of goods that the GPO's members wish to procure. Next, the selected vendors prepare for and receive the RFP (600). A bid is then generated by each vendor and a response is sent to the GPO (700). The GPO reviews each bid (400) and, based upon pre-established criteria, awards or rejects each bid (500). The vendors receive notification of-awards (204). Eventually orders are placed and the price charged is the price negotiated by the GPO for its members. Fulfillment occurs in a process external to the present invention.

The present embodiment maintains all data related to the transaction for further management of the contracts and auditing purposes. Each user may access the system to manage specific aspects of the data over the entire transaction lifetime. The specific aspects that may be managed are determined by the type of user. For example, a GPO is allowed to create an RFP while a vendor is limited to responding to an RFP with a bid proposal. Each user has specific access permissions that determine the ultimate functionality experienced. While the GPOs are allowed to manipulate the bid price, it is recommended that they only do so in conjunction with the Vendor to correct any inputting or procedural error. The original Vendor entry is maintained by the system as historical data that may be recalled at a later date, such as for auditing purposes.

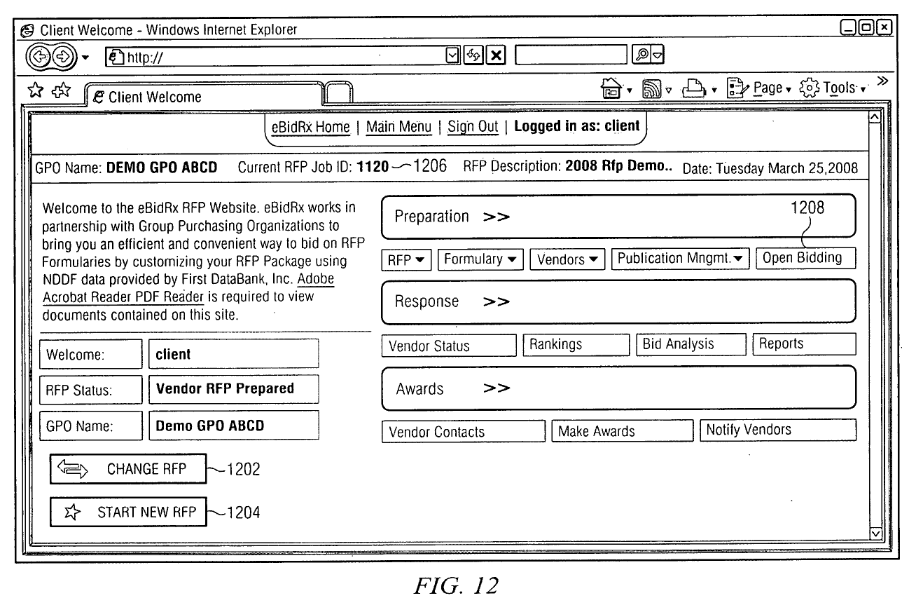

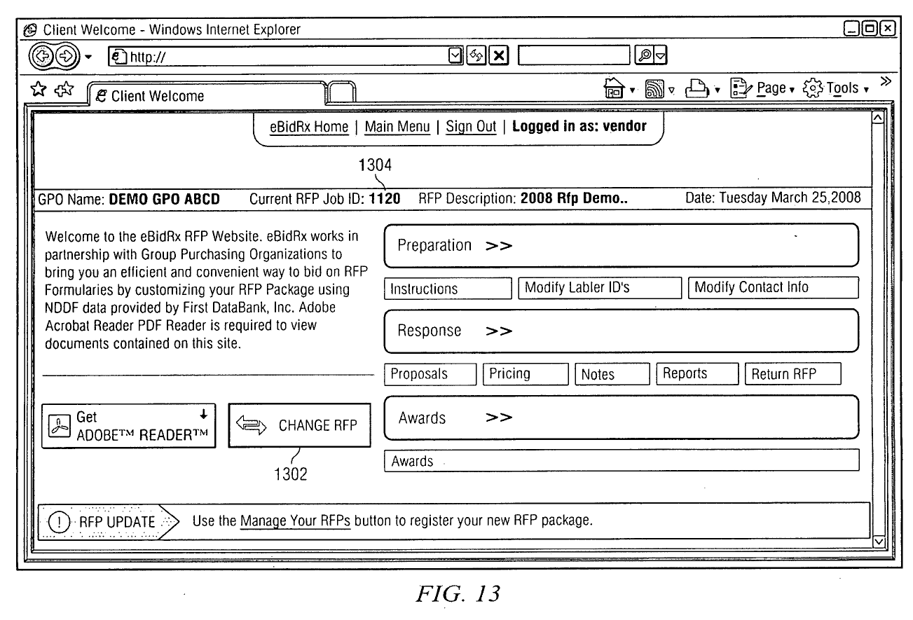

In the present embodiment, a GPO is presented with an interface similar to that shown in FIG. 12 upon logging in. As used herein, the term “interface” includes any Web interface or other special purpose GUI that allows a user to access the system. A vendor is presented with an interface similar to that shown in FIG. 13 upon logging in. Each particular interface contains hyperlinks or buttons to actuate various functionality specific to the user's permissions.

GPO—Prepare RFP

By default, upon login the system of the present embodiment assumes the GPO wishes to work with the RFP from the previous login session. The unique job ID (1206) associated with the RFP is displayed at the top of the interface as shown in FIG. 12. However, the GPO may instead select another preexisting RFP (1202) or may create an entirely new RFP (1204).

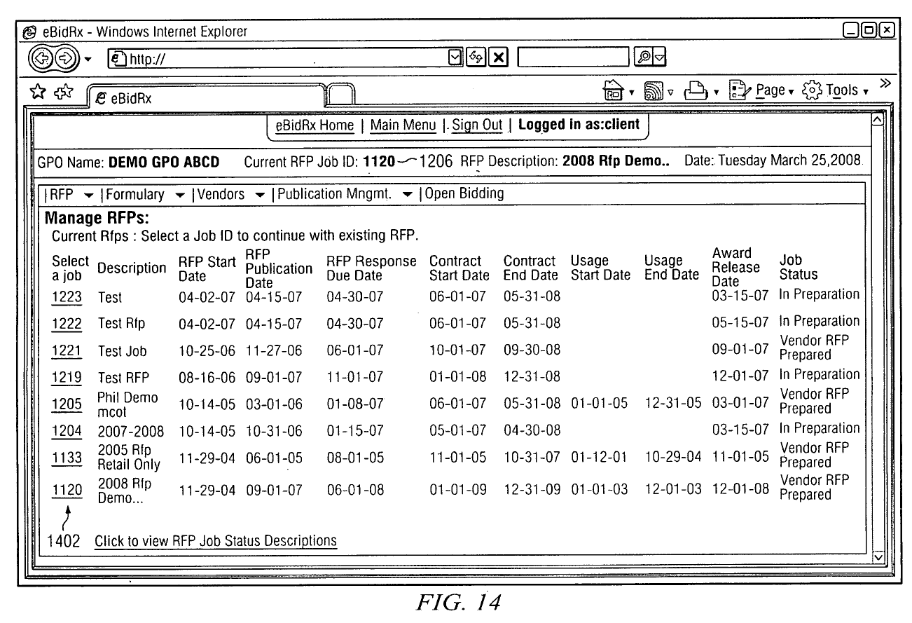

If the GPO wishes to select another preexisting RFP (1202), he or she is presented with an interface as in FIG. 14. From this interface the GPO may view preexisting RFP details such as the unique job ID associated with the RFP (1402), description, start/publication/response dates, contract start and end dates, award dates, and the job status. Selecting a particular job ID (1402) switches the system to the selected RFP. Again, the job ID (1402) of the newly selected RFP is then displayed at the top of the interface for reference (1206).

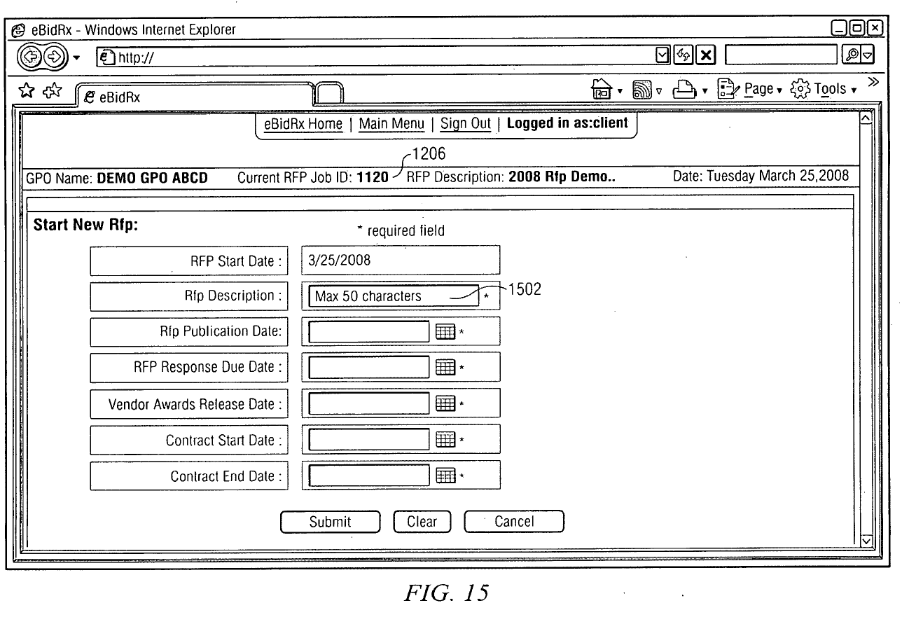

Referring again to FIG. 12, if the GPO wishes to create a new RFP (1204), he or she is presented with an interface as in FIG. 15. From this interface the GPO may enter a character description for the RFP (1502), its publication and response dates, its vendor awards release dates, and its contract start and end dates—if any of such dates are known. The system assigns a unique job ID to the RFP as well as its start date (i.e., the date of creation).

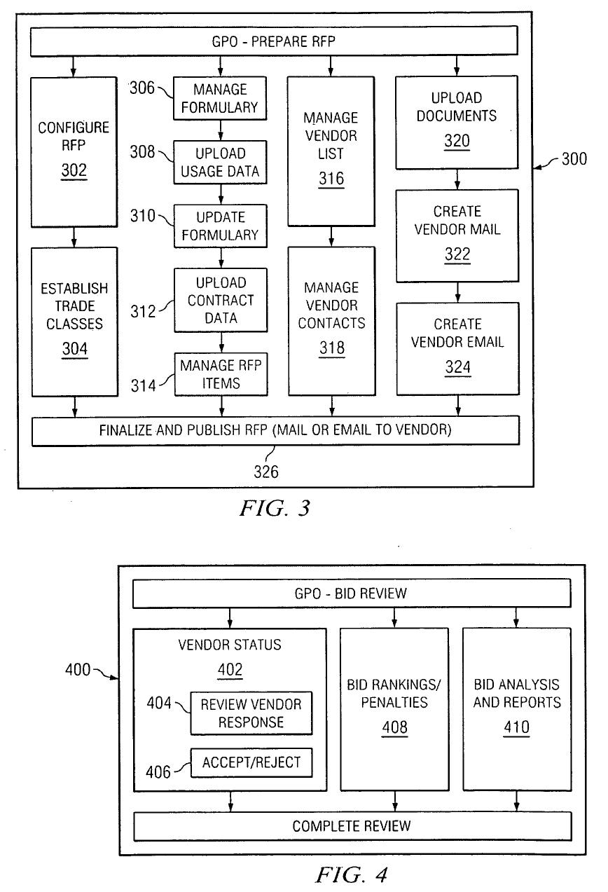

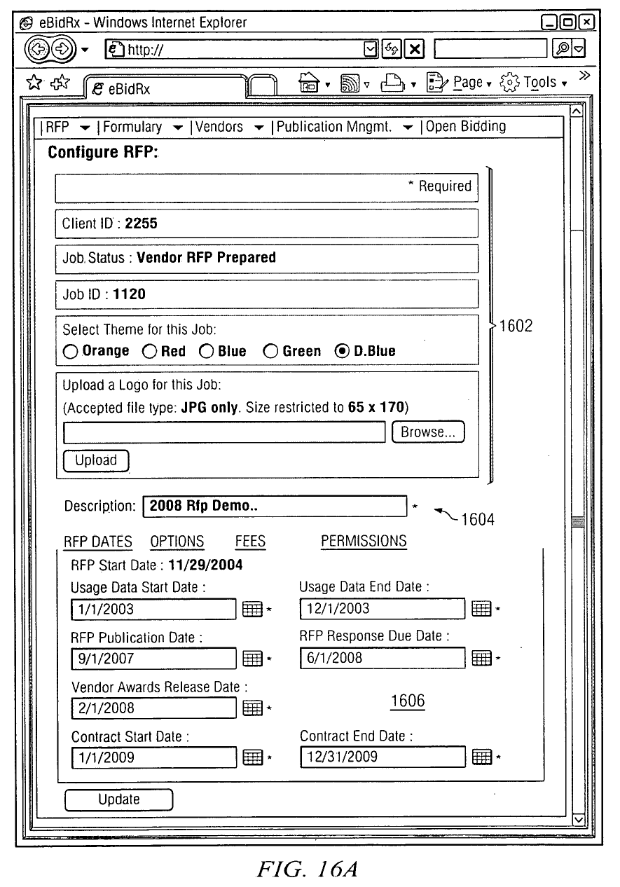

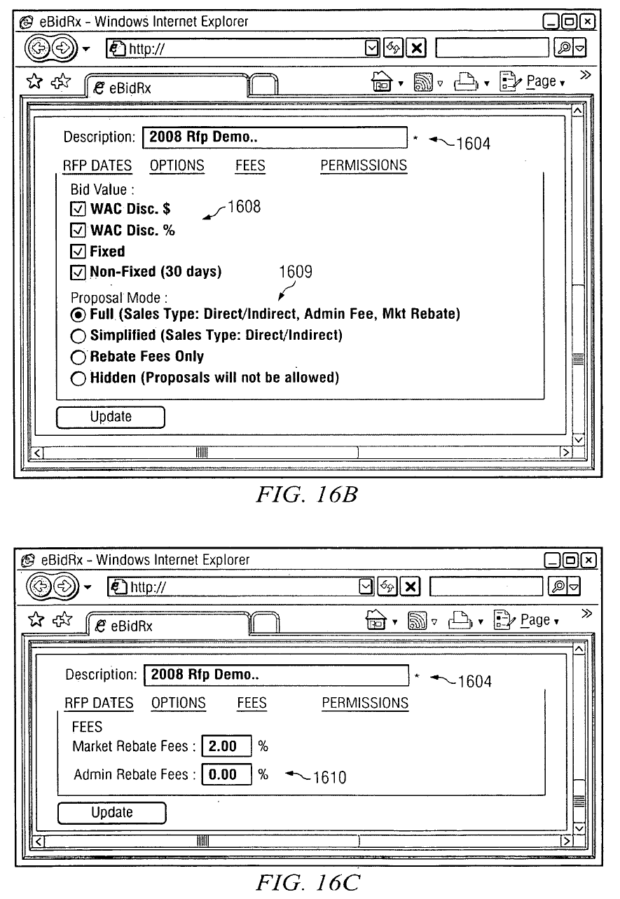

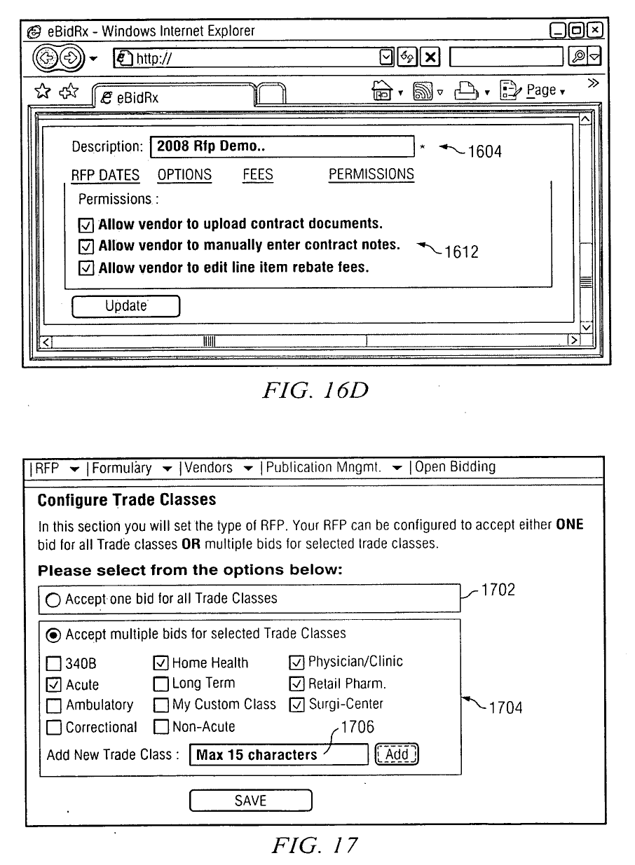

Once an RFP is either created or chosen, the GPO may begin the preparation process. FIG. 3 presents a flow diagram representing the major function steps provided by the system to facilitate this action. With either a new or preexisting RFP, the GPO may configure its various attributes (302). FIGS. 16A-16D each depict the interfaces that facilitate these particular configuration changes.

As shown in FIG. 16A, the GPO may modify the color associated with the RFP or upload an identifying graphic (1602) to distinguish the RFP from others. Also, the textual description may be altered (1604) along with the various associated RFP dates (1606). Selecting a link or button beneath the description text box (1604) allows the GPO to modify other aspects of the RFP (i.e., RFP Dates, Options, Fees, and Permissions).

For example, selecting “Options” presents the GPO with the interface as in FIG. 16B. This interface allows the GPO to designate the Bid Value type (such as WAC discount amount, WAC discount percent, fixed pricing, and non-fixed pricing) (1608) as well as the proposal mode (such as Full, Simplified, Rebate Fees, or Hidden) (1609). A Full proposal allows for direct/indirect sales, admin fees, or market rebates to be utilized. A Simplified proposal allows only direct/indirect sales. In Hidden mode, no proposals are allowed at all. A Rebate Fees proposal allows direct/indirect sales and marketing and administrative rebate fees.

Selecting “Fees” from the interface of FIG. 16B presents the GPO with an interface as in FIG. 16C. This interface allows the GPO to apply a specific market rebate fee or an admin rebate fee (1610) to the RFP. The GPO may input either value as a percentage. Administrative Fees are reimbursements to the GPO from the vendor that cover costs related to operations. By law these reimbursement fees are limited to 3%. Marketing Rebate Fees are reimbursements to the GPO from the vendor to cover marketing costs that the GPO may incur.

Selecting “Permissions” from the interface of FIG. 16B presents the GPO with an interface as in FIG. 16D. This interface allows the GPO to allow or disallow certain actions (1612) by the vendors related to the specific RFP (1604). For example, the GPO may allow a vendor to upload documents, enter contract notes, or edit line item rebate fees by granting special permissions (1612).

Referring again to FIG. 3, as a further configuration option the GPO may establish specific trade classes for the RFP (304). Selecting this function presents the GPO with the interface as in FIG. 17. From this interface, the RFP can be configured to accept one bid for all trade classes (1702) or multiple bids for selected trade classes (1704). A utility is also provided to designate new or custom trade classes (1706) by manually entering a textual description of the new class. Examples of trade classes shown include: 340B; Acute; Ambulatory; Correctional; Home Health; Long Term; Non-Acute; Physician/Clinic; Retail Pharmaceutical; and Surgi-Center.

Under federal law, all businesses that sell to the same customer type must be eligible to receive equal pricing consideration, such as discounts and special offers. To assure compliance with the law, most pharmaceutical companies have developed lists of similar customers and grouped them into different classes of trade (i.e., the “trade classes” as mentioned above). Pricing schedules and tactics are then developed for each class of trade.

GPOs typically maintain a formulary of preferred pharmaceuticals. The formulary refers to a list of products/compounds that is considered by the GPO/Healthcare Entity as being clinically acceptable for their membership or their own use, such as in the case of a single facility, chain, or IDN. The present embodiment maintains the GPO's formulary for use in creating the RFP. A unique formulary may be associated with each RFP, and may incorporate formularies from other RFPs or may consist solely of pharmaceuticals in the existing RFP. Referring again to FIG. 3, the formulary for the present RFP may be managed by selecting the appropriate “manage formulary” menu item (306).

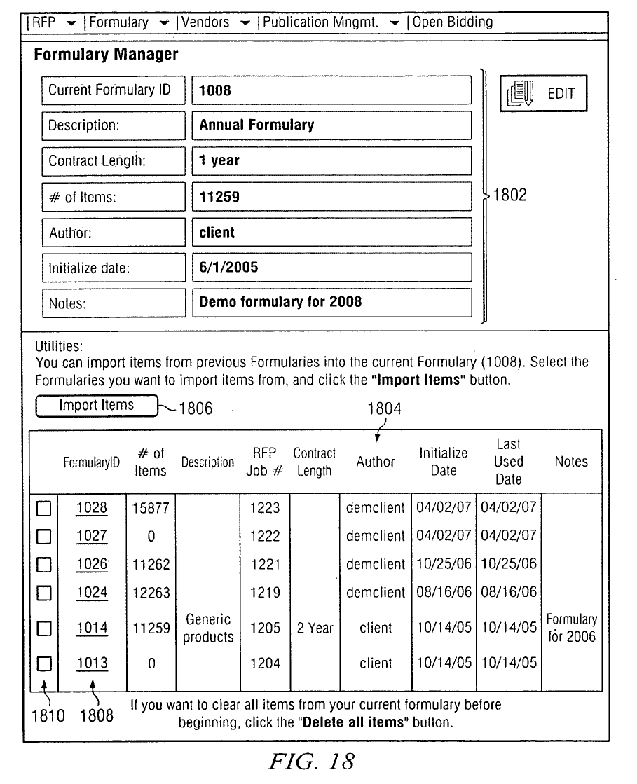

To manage the formulary (306), the GPO is presented with an interface such as that shown in FIG. 18. From this interface, the GPO may edit the formulary attributes (1802) such as description and contract length. Also, past formularies may be imported (1804) by selecting the appropriate checkboxes (1810) next to the desired formulary and selecting the “import items” button or link (1806). The contents of each formulary may be subsequently reviewed after selecting the associated unique formulary ID (1808).

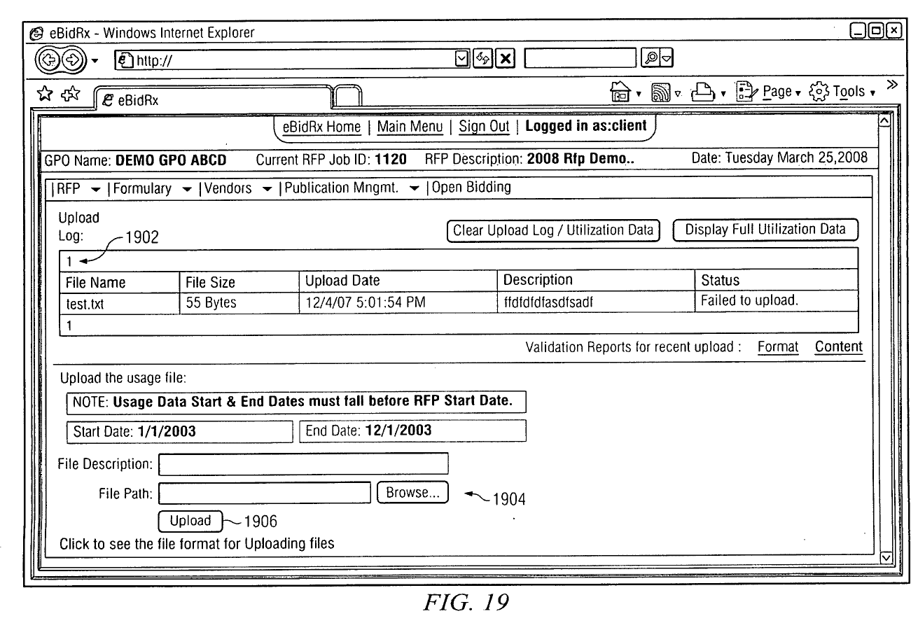

Referring again to FIG. 3, the GPO may upload pharmaceutical usage data to be associated with the RFP formulary (308). If this function is selected, the GPO is presented with an interface as in FIG. 19. From this interface, the GPO may review the current usage data assigned to the formulary (1902) or may upload new usage data. To upload data, the GPO may merely browse to the file (1904) and select the “upload” button or link (1906). Usage Data represents aggregated sales volumes for the GPO across all its members. This data is then used to leverage pricing from suppliers for the items listed on the RFP.

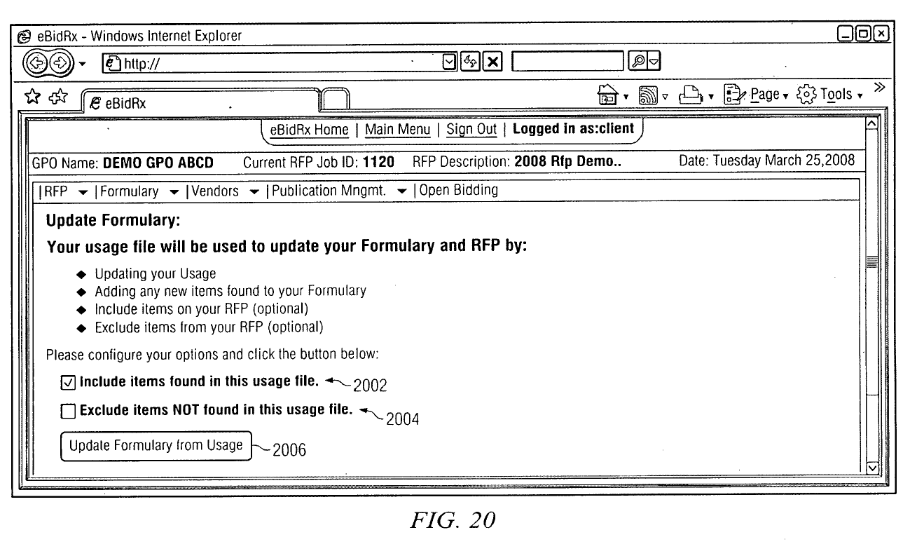

Referring again to FIG. 3, once the usage data is uploaded the GPO may update the RFP formulary from the usage data (310). Once the “Update Formulary” menu item is selected, the GPO is presented with an interface such as that in FIG. 20. From this interface, the GPO may choose whether to update the formulary with pharmaceuticals in the usage data file (2002) and/or exclude pharmaceuticals from the formulary that are not present in the usage data file (2004). Once this decision is made, the formulary is updated after selecting the “Update Formulary from Usage” button or link (2006).

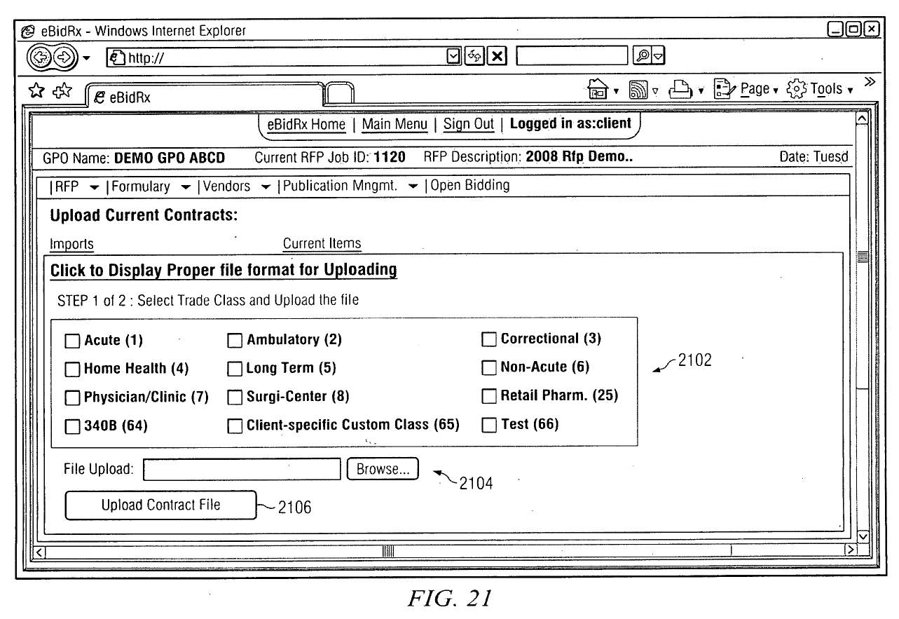

Referring again to FIG. 3, the “Upload Contract Data” functionality (312) allows the GPO to upload contract data into the system to add contract items into the RFP formulary. If the GPO selects this function, an interface such as that in FIG. 21 is provided. From this interface, the GPO may first select the trade classes—if necessary—to which the contract data will apply (2102). If the RFP was previously configured for all trade classes, this selection will not be possible. Next, the GPO may browse to the electronic contract data file (2104) and upload the file to the system (2106). Uploading the contract data is optional. In the RFP process, this information may be used by the GPO to compare the current RFP pricing they are receiving with the pricing they have for items on contract.

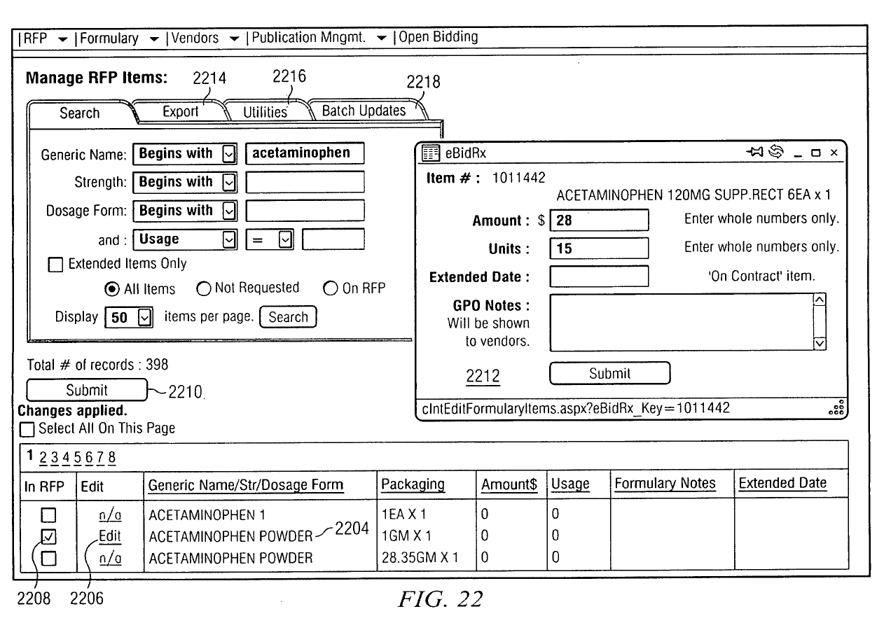

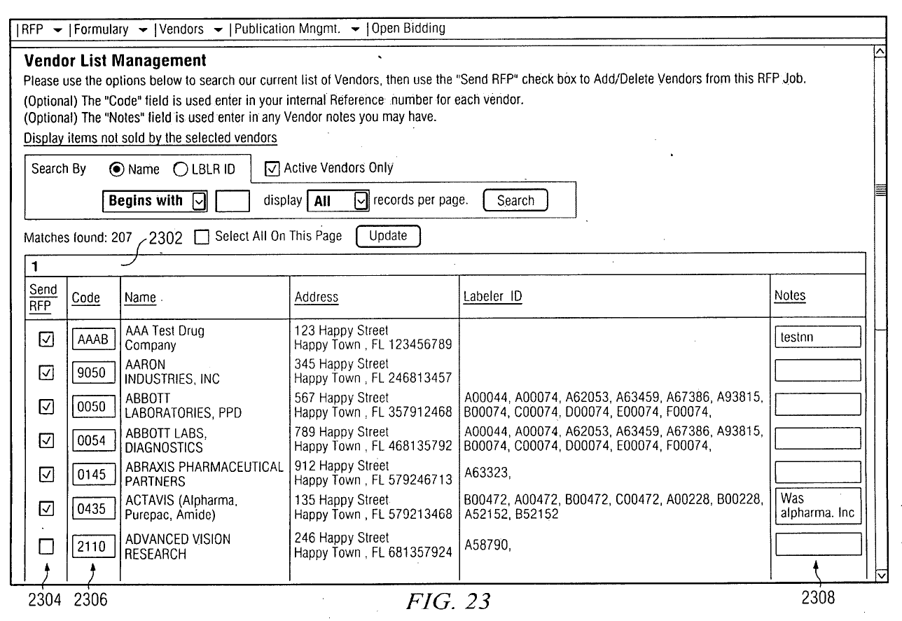

Referring again to FIG. 3, pharmaceuticals may be added to the RFP using the “Manage RFP Items” functionality (314). Once this menu item is selected, the GPO is presented with an interface such as that in FIG. 22. From this interface, the GPO may conduct a search against the NDDF drug database to locate specific pharmaceuticals. The search may be conducted using the generic name and further refined by providing attributes such as strength, dosage form, and/or usage or amount data. Once the correct drug for the RFP is located, it may be added to the RFP.

In FIG. 22, Acetaminophen Powder (2204) in 1 GM×1 packaging is added to the current RFP by selecting the corresponding checkbox (2208) and submitting the changes (2210). Once the drug is added to the RFP, an “Edit” link becomes visible (2206). The GPO may then edit various attributes of the newly added drug, such as the dollar amount and units (2212).

The list of selected RFP items may also be exported (2214) to various editable file formats such as XML, spreadsheet, and text. Utilities (2216) also allow for the GPO to add or remove the pharmaceuticals selected for the RFP to or from the RFP formulary. Batch updates (2218) may also be made to commit mass changes to the formulary and RFP at one time.

Referring again to FIG. 3, the list of vendors to which the current RFP should be submitted may also be managed by the GPO. Alter selecting the “Vendor Management” functionality (316), the GPO is presented with an interface such as that shown in FIG. 23. From this interface, a list of all vendors registered with the system and available to receive RFPs is displayed (2302). The GPO may then select all or a subset of the available vendors by checking the appropriate boxes (2304). A unique vendor code may also be assigned (2306) in addition to notes for the specific vendors (2308). Venders are either included or excluded in the RFP bidding process by these actions. The data in the “labeler ID” column is used to match Vendor products with the current formulary products.

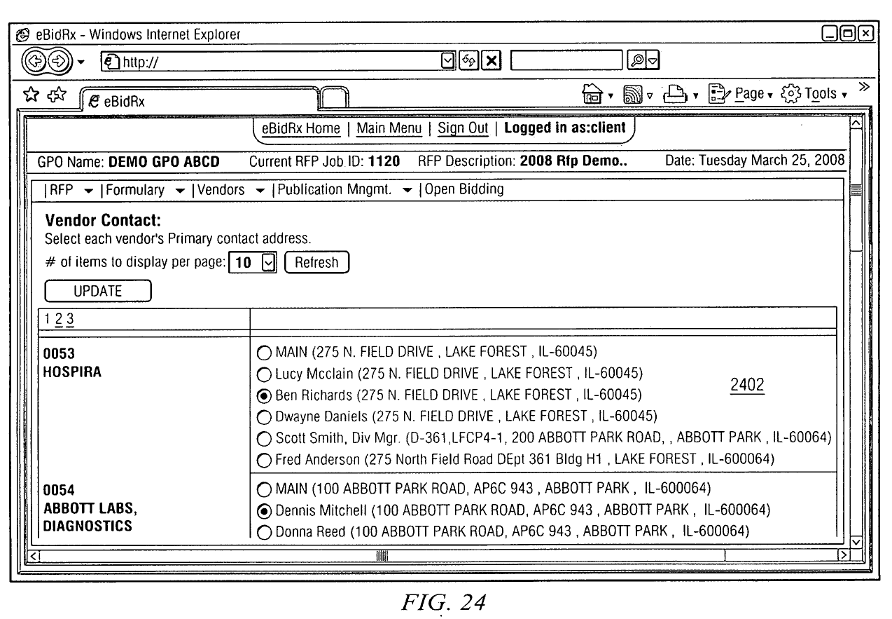

Referring again to FIG. 3, each vendor may have multiple primary contact addresses. Accordingly, the system allows the GPO to manage the vendor contacts to ensure the RFP goes to the correct regional or local office. The GPO may select the “Vendor Contacts” menu item to manipulate this information. After choosing this functionality (318), the GPO is presented with an interface such as that in FIG. 24. From this interface, the GPO may select the appropriate contact address for the vendors of concern (2402).

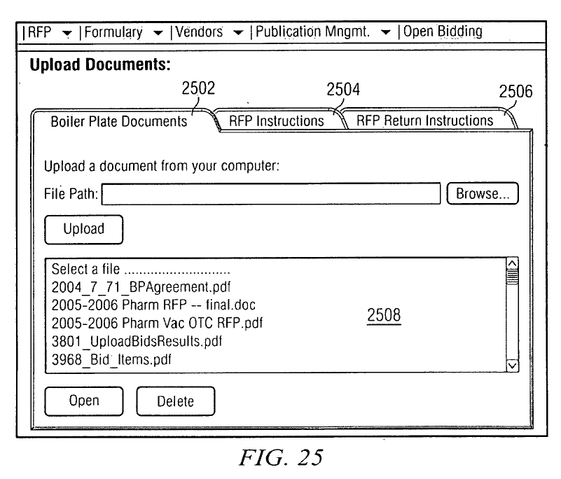

Referring again to FIG. 3 additional documents may also be added to the RFP by the GPO using the “Upload Documents” functionality (320). Once this functionality is selected, the GPO is presented with an interface such as that in FIG. 25. With this interface, the GPO may upload external documents to the system (2502) for display to all vendors receiving the RFP. A list of uploaded documents is then displayed (2508). The GPO may also edit and format RFP text instructions within the interface (2504) and provide detailed RFP return instructions (2506).

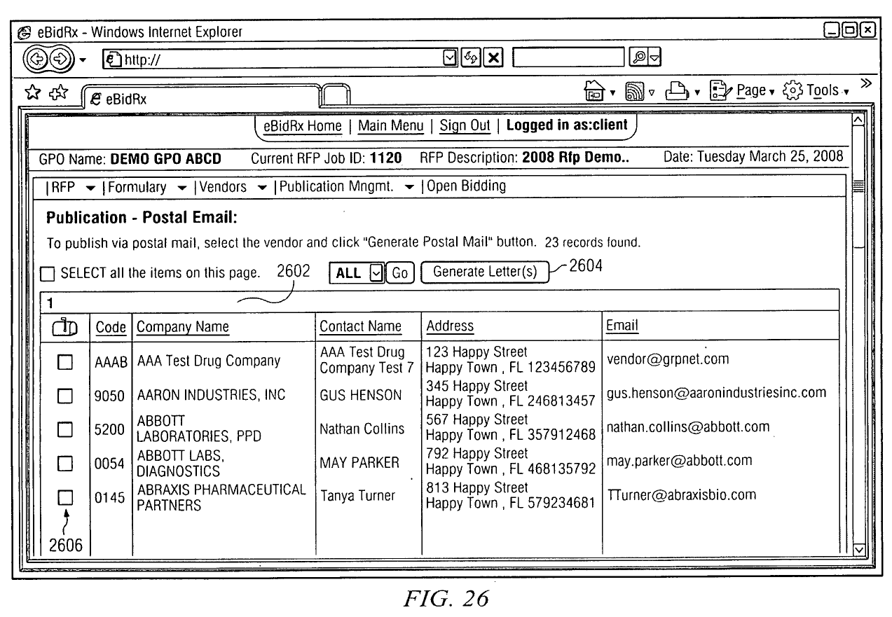

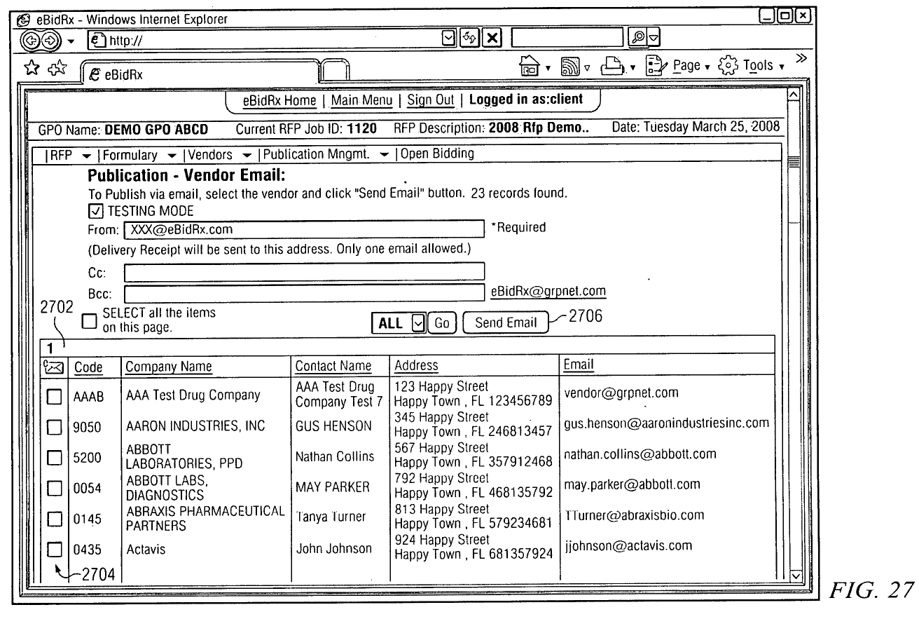

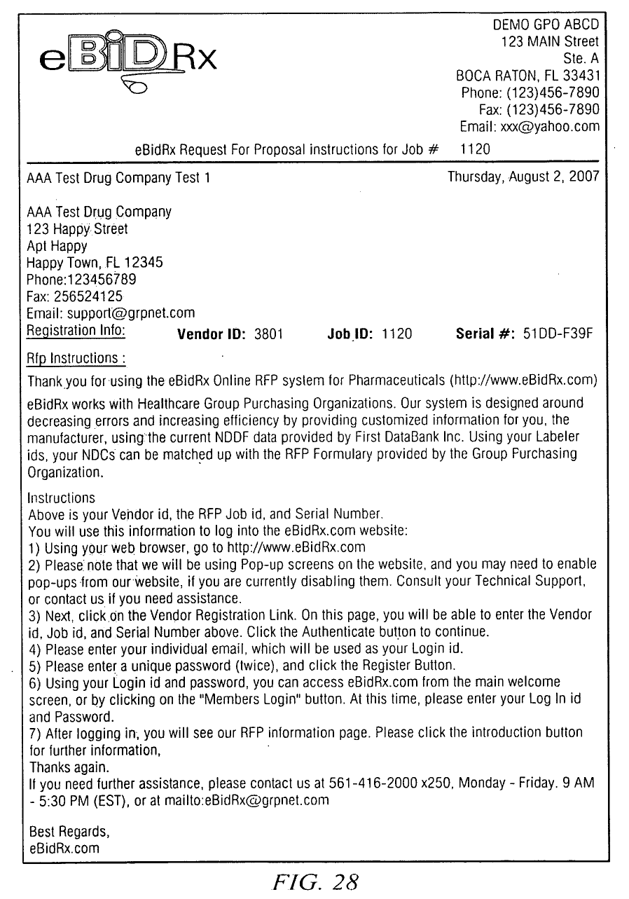

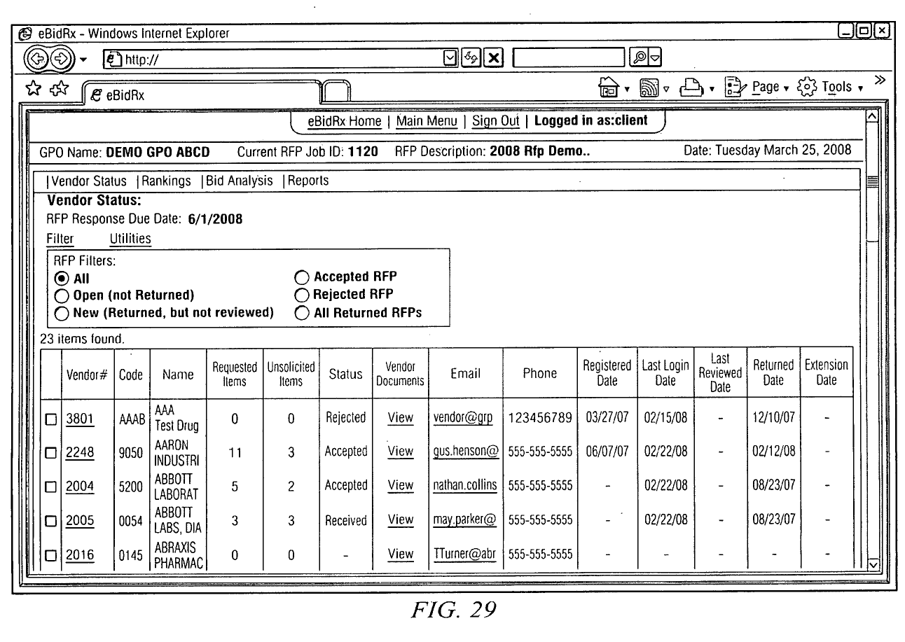

Referring again to FIG. 3, once an RFP is completed and is ready to publish (i.e., submit to the appropriate vendors), it may be either mailed via the postal service or emailed. If the GPO wishes to create mail form letters announcing the availability of the RFP, the “Create Vendor Mail” functionality (322) may be used. Once this functionality is selected, the GPO is presented with an interface such as that in FIG. 26. From this interface, a list of all vendors assigned to the RFP is displayed (2602). Each vendor that is to receive a mail message may be selected (2606). This may be all or a subset of the available vendors. Once selections are made, the letters may be generated by selecting the “Generate Letter(s)” button or link (2604). The generated letter is, similar to that depicted in FIG. 28. The letter provides notification to the vendor of the RFP as well as information on how to access it from within the system. Further, any additional instructions that were previously uploaded or otherwise added to the system via the aforementioned commands are displayed on the letter.

Referring again to FIG. 3, if the GPO wishes to publish the RFP to the vendors via email, the “Create Vendor Email” functionality (324) may be used. Once this functionality is selected, the GPO is presented with an interface such as that in FIG. 27. From this interface, a list of all vendors assigned to the RFP is displayed (2702). The GPO need only select all or a subset of the available vendors (2704) and select the “Send Email” button or link (2706) to complete the email notification. The system automatically generates information similar to that in the mail message of FIG. 28 and emails it in an electronic format to the selected vendors.

Referring again to FIG. 3, once all changes have been made to the RFP and the GPO is satisfied that it is ready to accept proposals the RFP is finalized (326). At this point, the system waits until “RFP Publication Date” is reached. This date may be manipulated from the “Configure RFP” interface of FIG. 16. Referring again to FIG. 12, to finalize the RFP the GPO selects the “Open Bidding” function (1208). This function closes-out the RFP and prevents all further changes to its requested items.

Vendor—Prepare Bid

Referring to FIG. 13, by default, upon login the system of the present embodiment assumes the vendor wishes to work with the RFP from the previous login session. The unique job ID (1304) associated with the RFP is displayed at the top of the interface. However, the vendor may instead select another preexisting RFP (1302) to process.

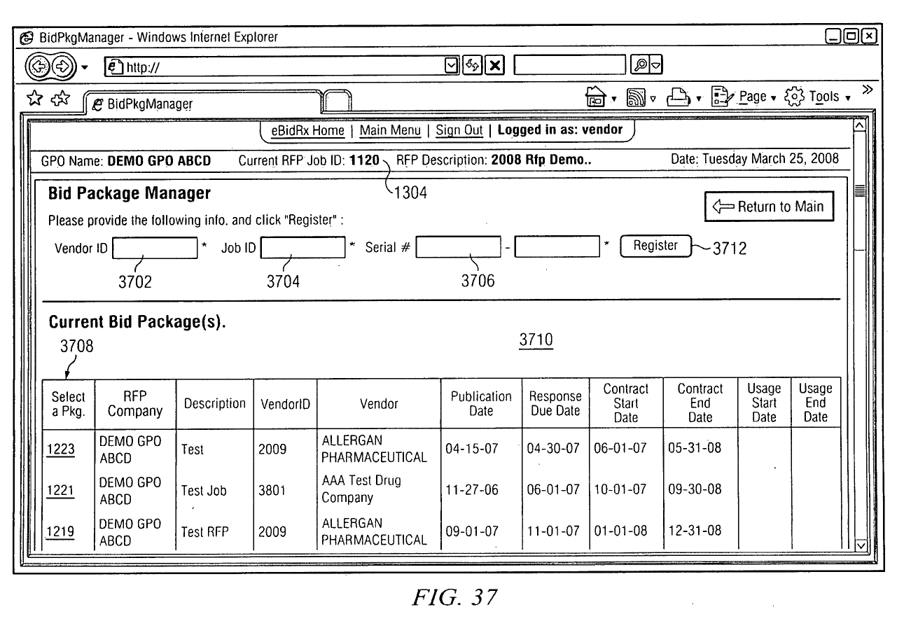

If the vendor wishes to select another RFP to process (1302), he or she is presented with an interface such as that in FIG. 37. From this interface, the vendor may select a preexisting RFP (3708) from the displayed list of RFPs (3710), or may choose a new RFP. When the vendor receives notice of publication of an RFP from a GPO, the letter or email contains the Job ID and Serial Number assigned to the RFP. The vendor may select this newly published RFP by entering its Vendor ID (3702) and the published Job ID (3704) and Serial Number (3706). Once this is complete and the new RFP is registered (3712), the new RFP will become the current RFP (1304).

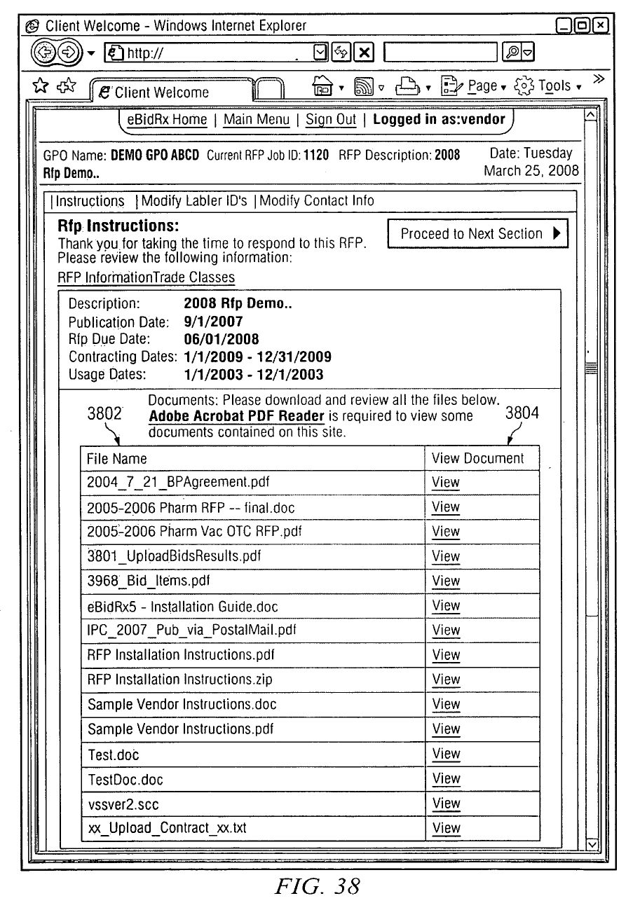

At the onset of the bid proposal stage, it is prudent for the vendor to prepare for the reply to the RFP. FIG. 6 presents a flow diagram representing the major function steps provided by the system to facilitate this action. The vendor may first review any instructions for the RFP provided by the GPO. To do this, the vendor selects the “Instructions” functionality (602). Once this functionality is chosen, the vendor is provided with an interface such as that in FIG. 38. From this interface, the list of documents previously uploaded and attached to the RFP by the GPO is displayed (3802). Each document may be viewed by selecting the appropriate link (3804).

The vendor may edit their list of assigned numbers, known as “Labeler IDs”, which are used to identify the pharmaceuticals they can supply to the GPO. This list is used to match the drugs requested in the RFP Formulary with the vendor's pharmaceuticals.

The Labeler Identifier (LBLRID) column in the NDC Table is a six-character alphanumeric code that is assigned to a product by First DataBank and represents the product labeler (a manufacturer, distributor, or re-packager). The first character of LBLRID is alphabetic and represents a division within a company. The last five characters are numeric and represent the parent company. Products that are distributed from different divisions of the same company usually will have unique alphabetic characters preceding the shared numeric code. The LBLRID should not be confused with the five-digit labeler code that is assigned to a company by the FDA and that comprises the first five digits of an NDC. The LBLRID is independent of the NDC.

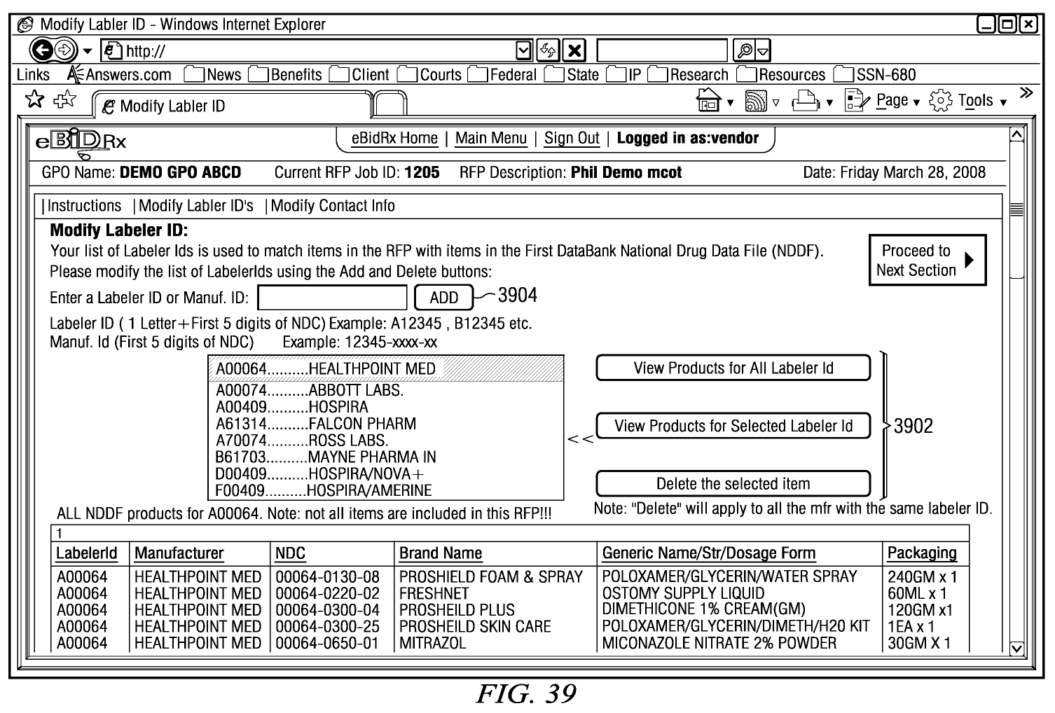

Referring again to FIG. 6, to assign or modify the Labeler ID the vendor selects the “Modify Labeler ID” functionality (604). Once this functionality is chosen, the vendor is provided with an interface such as that in FIG. 39. From this interface, the vendor may review the products available for a particular Labeler ID or may view all products for all Labeler IDs (3902). Additional Labeler IDs may also be assigned to the RFP (3904) to increase the list of available products.

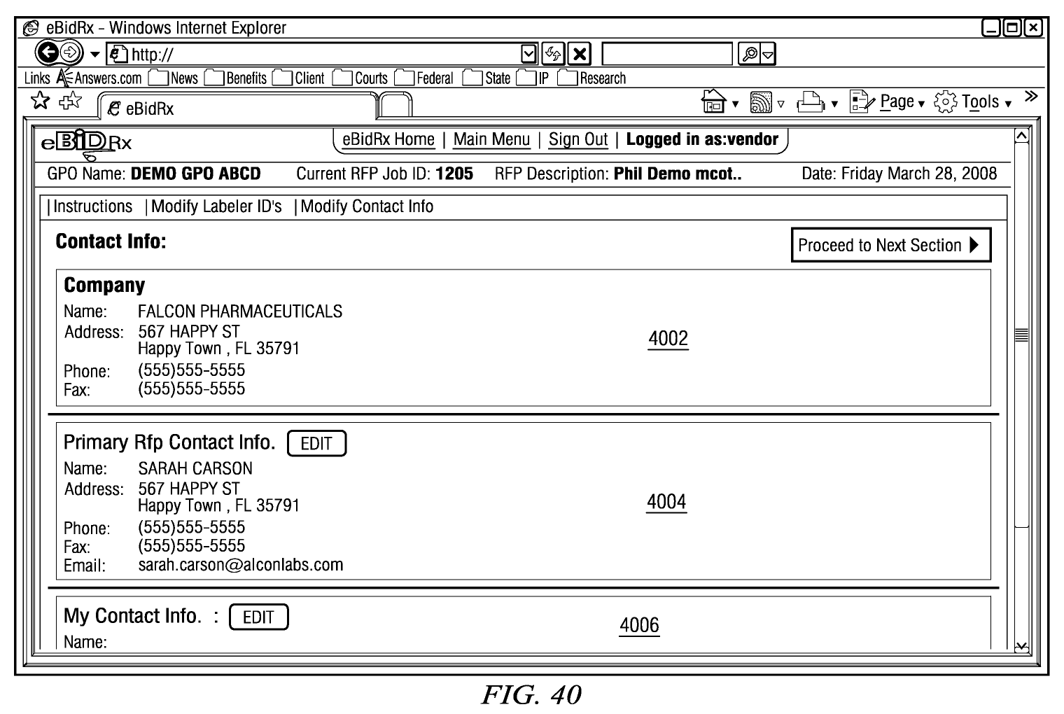

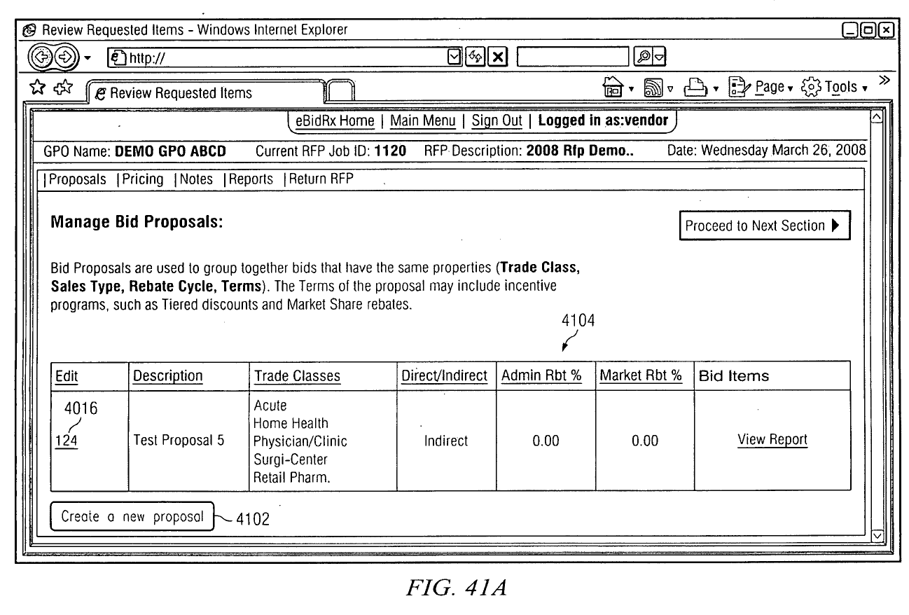

Referring again to FIG. 16, the vendor may modify its contact information by selecting the “Modify Contact Info” functionality (606). Once this functionality is chosen, the vendor is provided with an interface such as that in FIG. 40. This interface displays the current company information (4002), primary contact information (4004), and current contact information (4006). The interface also allows the primary and current contact information to be modified.

Vendor—Respond with Bid

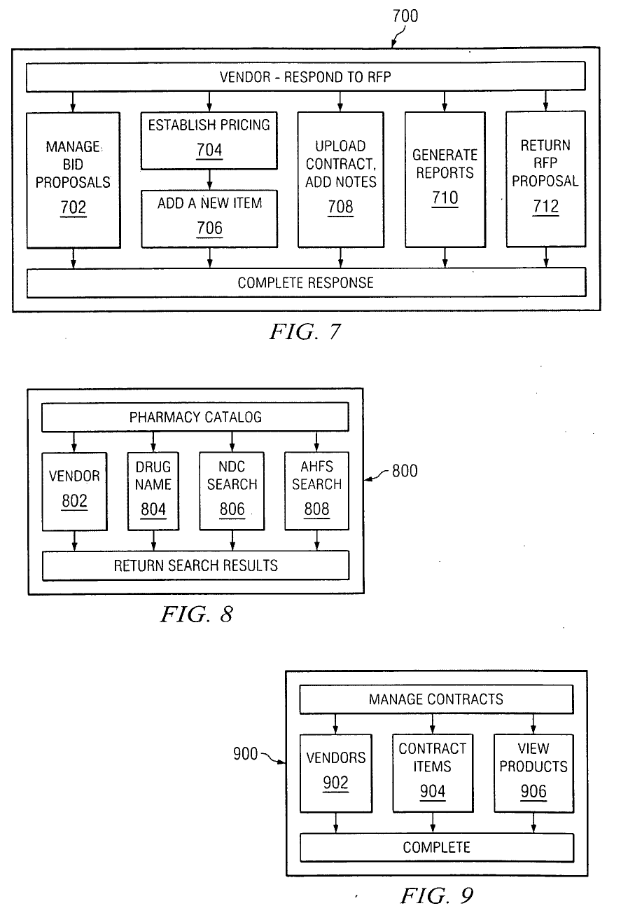

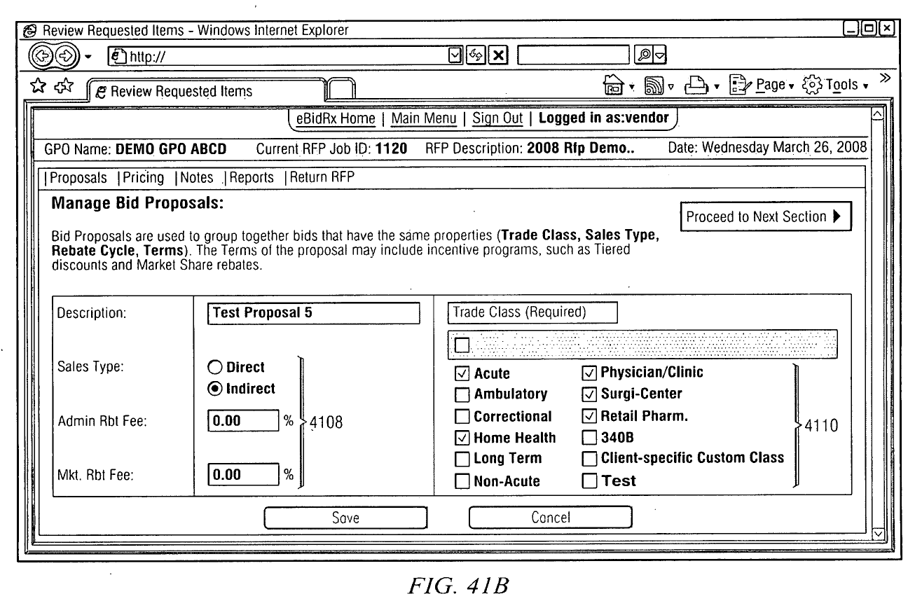

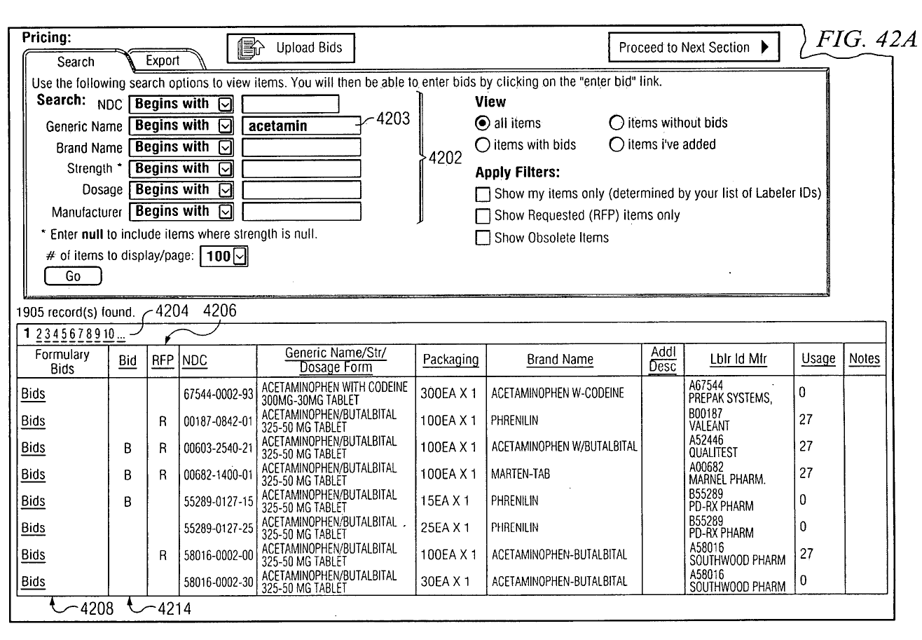

Once the vendor has prepared to respond to the RFP, an actual response (or bid) may be generated. FIG. 7 presents a flow diagram representing the major function steps provided by the system to facilitate this action. The vendor must first create a bid proposal by selecting the “Proposals” functionality (702). Once this functionality is selected, the vendor is presented with an interface such as that in FIG. 41A. From this interface, the vendor may create a new bid proposal (4102). Newly created proposals are then displayed for further editing (4104). It is necessary to edit each proposal in the event that the RFP specified multiple trade classes.

To edit a particular proposal, the vendor may select the unique proposal ID number (4106). Once a proposal is selected, the vendor is presented with an interface such as that in FIG. 41B. From this interface, the vendor may modify the proposal description, type, and rebate fees (4108). The vendor may also assign the proposal to specific trade classes (4110).

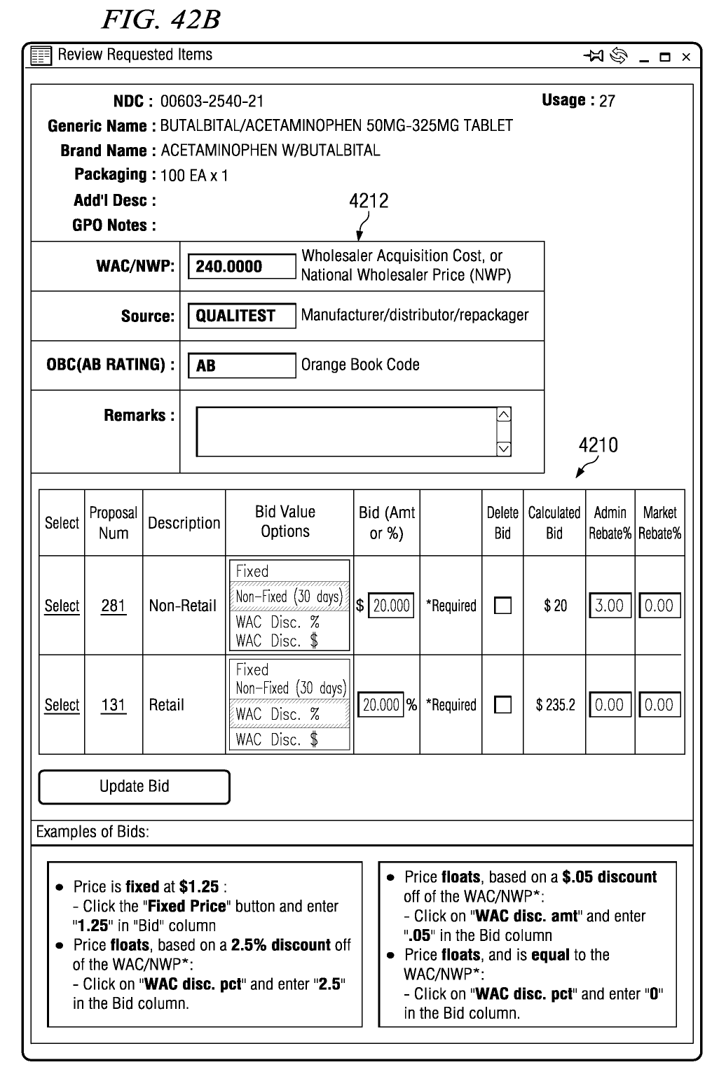

Referring again to FIG. 7, once the proposal is created, the vendor will typically establish pricing for the various pharmaceuticals it wishes to supply (704). The vendor is presented with an interface such as that in FIG. 42A to facilitate this action. From this interface, the vendor may search the NDDF drug database (4202) to locate appropriate pharmaceuticals.

FIG. 42A depicts a search using a portion of a drug name, “acetamin” (4203). The returned results are then displayed (4204). If the RFP contains a particular pharmaceutical, an indication is provided next to the pharmaceutical (4206). To establish pricing for the particular pharmaceutical requested, a corresponding link is supplied (4208).

Once the vendor selects the appropriate link (4208) an interface such as that depicted in FIG. 42B is provided. From this interface the vendor may modify the WAC/NWP, description of the source of the drug, Orange Book code, and provide any remarks (4212). Bid pricing details may be input as well (4210), establishing the actual price for the particular pharmaceutical. Once the bid price is set and the bid is updated, an indication is provided next to the appropriate pharmaceutical (4214).

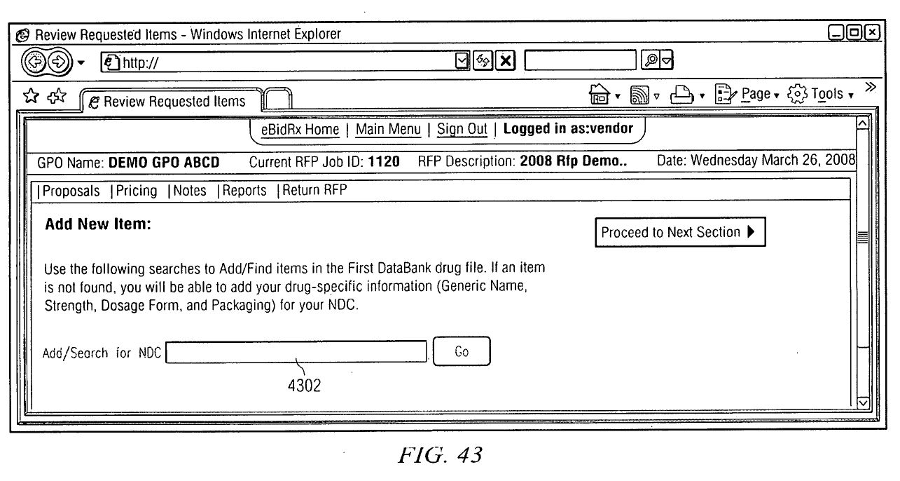

Referring again to FIG. 7, if a particular pharmaceutical does not appear in the search of the NDDF drug database, it may still be added to the proposal (704). If this functionality is selected, the system provides an interface such as that in FIG. 43 to accomplish the addition. From this interface, the vendor may enter the NDC of the pharmaceutical (4302). If the NDC of the item is not found, the vendor may then add the drug along with drug-specific information (i.e., generic name, strength, dosage form, and packaging) for the NDC.

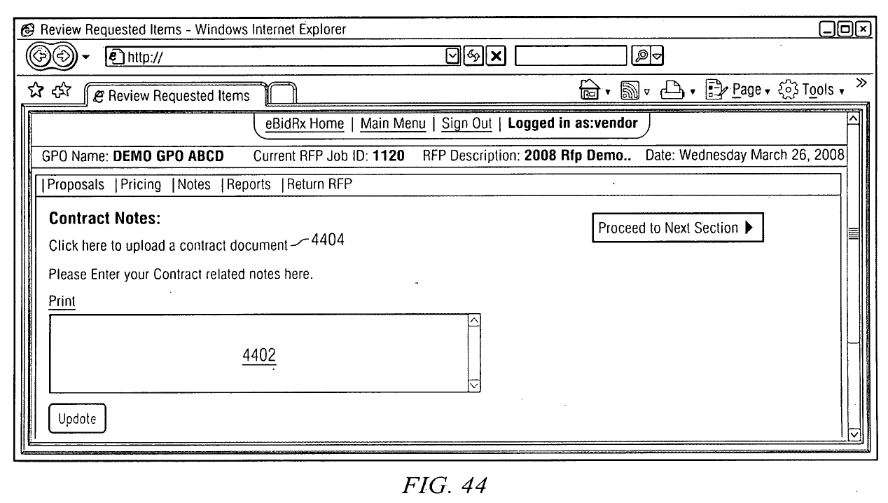

Referring again to FIG. 7, the present embodiment further allows the vendor to upload contract data and notes to the proposal for review by the GPO (708). If this functionality is selected, the system provides an interface such as that in FIG. 44. Text may be directly entered (4402) while external documents (such as PDF, DOC, and TXT files) may be uploaded (4404) directly and associated with the current bid.

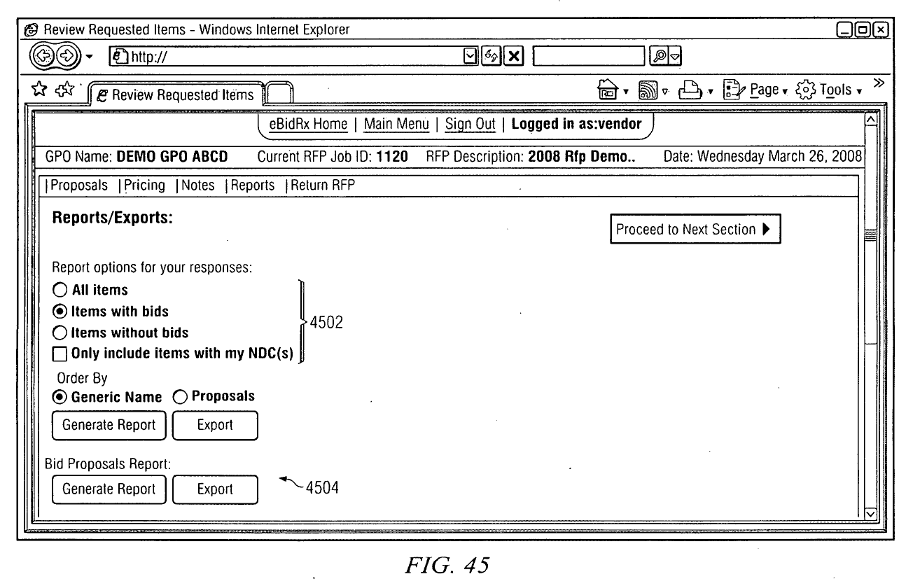

Referring again to FIG. 7, reports and export files may be created with the present embodiment to assist in reviewing or auditing the bid process (710). If this functionality is selected, the system provides an interface such as that in FIG. 45 to accomplish this. From this interface, the vendor may create a report or export file containing specified portions of the bid (4502), or may create a report or export file of the entire bid proposal (4504). The report is returned in document format while the export file is electronic for further editing.

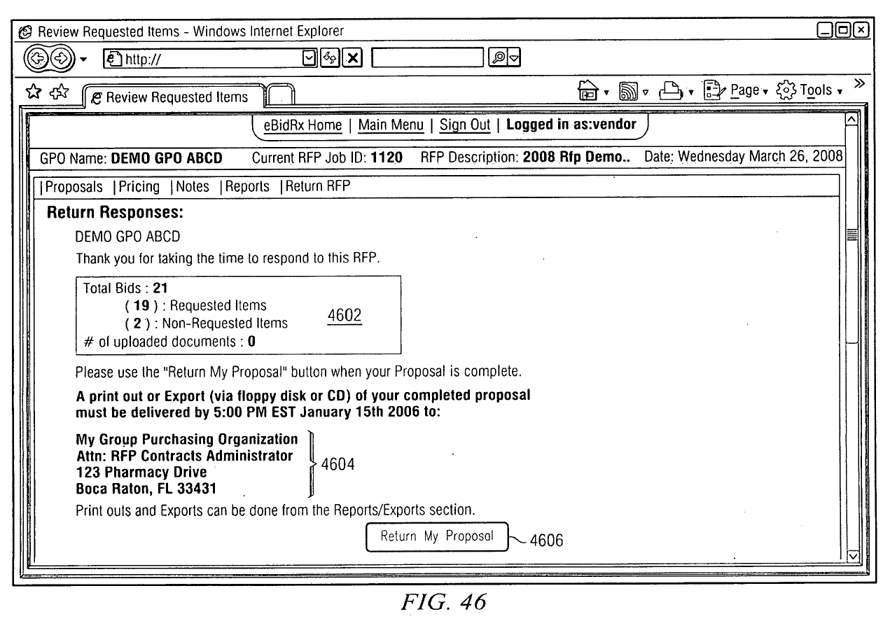

Referring once more to FIG. 7, once the proposal is finalized and reviewed it is ready to be submitted to the GPO (712). The system provides an interface such as that in FIG. 46 to accomplish this. From this interface, the vendor is shown a summary of the bid items (4602) as well as any submission notes previously attached by the GPO (4604). Selecting the “Return My Proposal” link or button (4606) finalizes the bid and prevents further modification. However, a GPO may reverse the submission if necessary, thus allowing the Vendor to further edit the response.

GPO—Review Bid

Once the bid is finalized and forwarded to the GPO, the GPO begins the bid review process. FIG. 4 presents a flow diagram representing the major function steps provided by the system to facilitate this action.

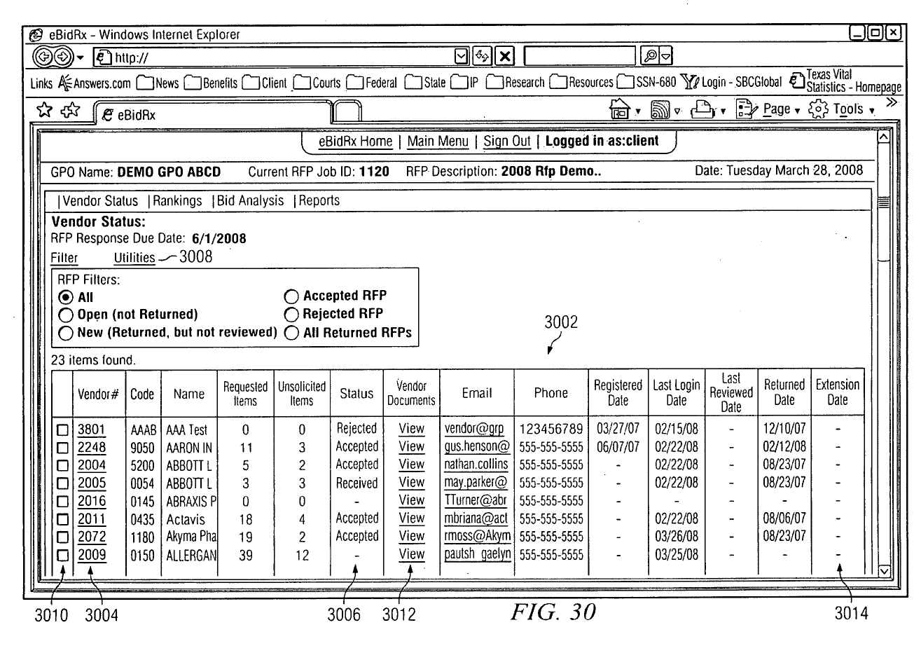

The GPO may first check the vendor status to determine the status of the bids (402). The system provides an interface such as that in FIG. 30 to determine status. A list of the vendors who received the RFP is displayed for review (3002) along with general bid information including bid status as accepted/rejected/pending (3006). From this display, links are provided (3004) to allow the GPO to review the detailed contents of the bid (404) and to edit certain elements of the bid such as WAC/NWP, bid value, and rebate percentages. Links to vendor-supplied documents are also provided (3012) to allow the GPO to review any bid-related documents or instructions. An extension of time for replying to a given bid may be requested by selecting the appropriate checkbox (3010) and entering the date from within the utilities functions (3008). The extension date is displayed along with the other bid data (3014). Bids are accepted or rejected (406) from this interface.

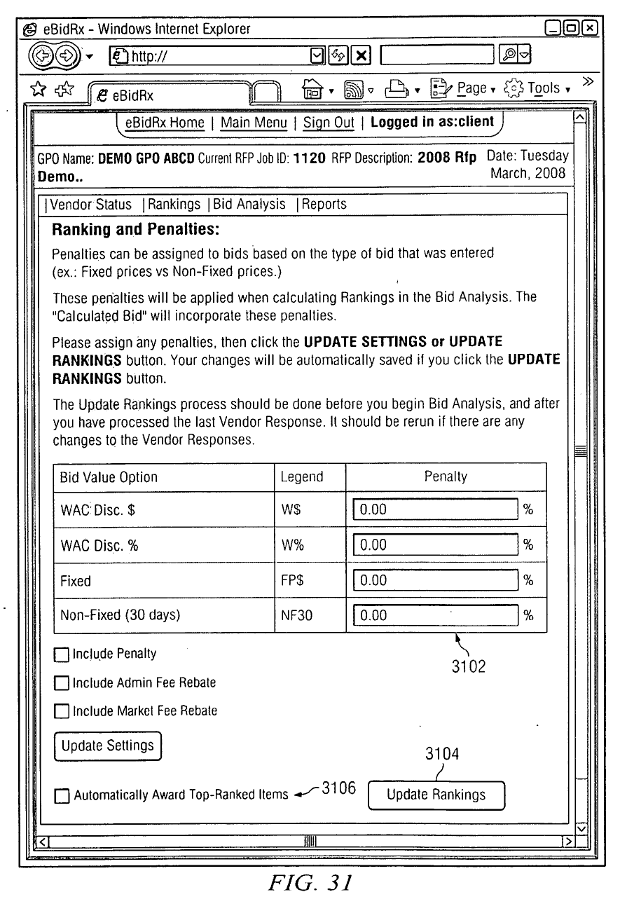

Referring again to FIG. 4, to assist in determining whether or not to accept/reject a bid the system allows the GPO to assign penalties for ranking purposes (408). The system provides an interface, such as that in FIG. 31, to allow this functionality.

Penalties may be assigned to bids based on the type of bid that was entered (for example, Fixed vs. Non-Fixed prices). Bid value options may be assigned percentage amounts (3102) that penalize (or weight) the corresponding bid value. For example, a percentage amount penalty can be applied to a non-fixed type contract in order to reduce the ranking of any bid proposals having a non-fixed price component. The system also allows the GPO to automatically award all top-ranked proposals (3106). The established penalties are applied when the GPO selects the “Update Rankings” button or link (3104).

Referring again to FIG. 4, penalties are applied when calculating rankings during the bid analysis phase (410). The Update Rankings phase (408) should be completed before beginning the Bid Analysis phase (410), and after the last vendor response is processed. It should be rerun if there are any changes to the vendor responses.

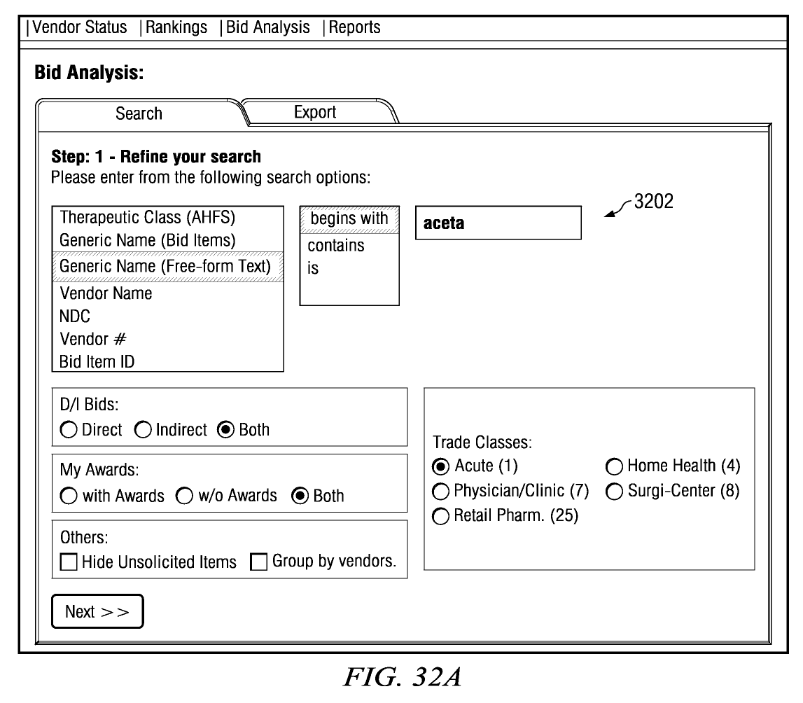

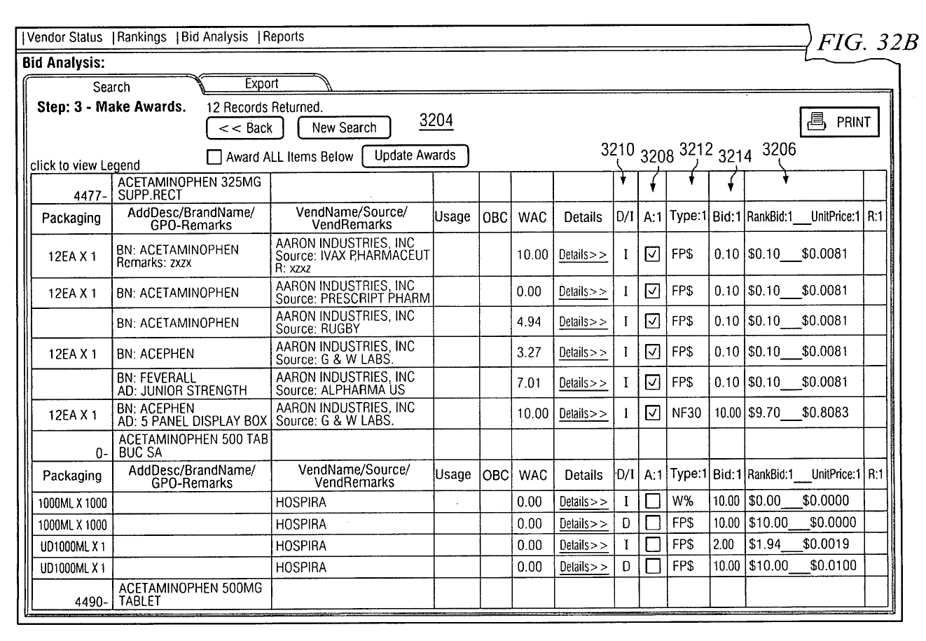

Referring once more to FIG. 4, once penalties are established, the system allows the GPO to analyze the results and generate reports based on the analysis (410). The system provides an interface such as that in FIG. 32A to conduct this analysis. From this interface, The GPO may search for a particular pharmaceutical that is in the RFP (3202). When the system locates the pharmaceutical, the results are displayed in another interface such as that of FIG. 32B. From this new interface, the GPO may evaluate the penalties and accept the pharmaceuticals within the highest ranking bids.

The displayed pharmaceutical products (3204) are grouped by their GCN Sequence numbers, (which are composed of the Generic Name, Strength, and Dosage Forms) and then ordered by packaging sizes. Additional details are provided to further define the products. For example, the D/I Column (3210) indicates Direct or Indirect pricing, the Type:1 column (3212) indicates the type of bid, the Bid:1 column (3214) shows the bid amount, and the RankBid:1 Column (3206) shows the vendor bid plus any assigned penalties.

This column (3206) also describes “UnitPrice,” which is used to evaluate bids regardless of packaging, allowing a “cost per pill” evaluation. This allows all products to have their pricing evaluated on a level playing field regardless of the particular packaging. The equation for determining “UnitPrice” is: [Unit Price]=[BID]/[Pack Size]/[Case Size].

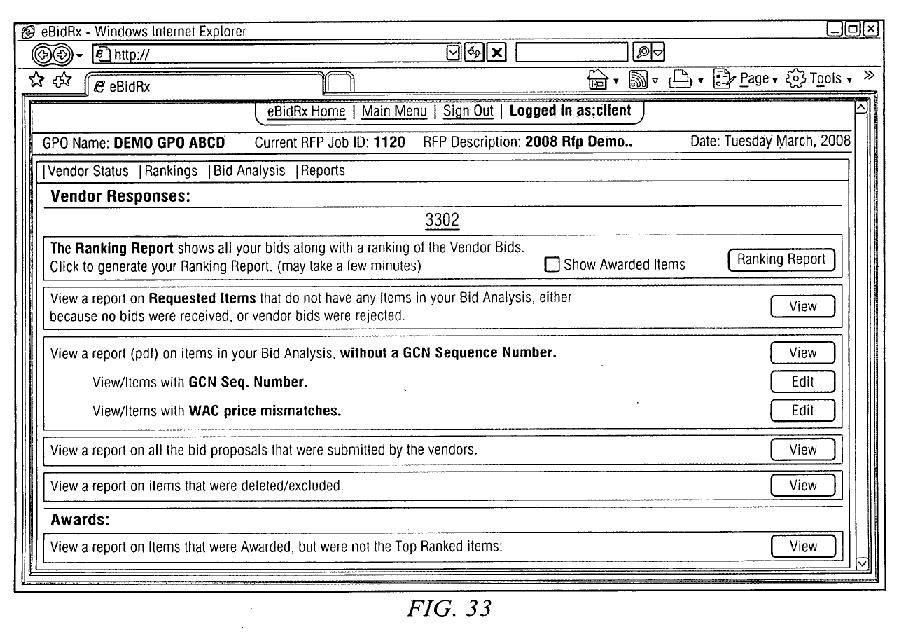

If the GPO wishes to award a particular item, the appropriate checkbox is selected (3208). Ranking reports may then be generated using the interface of FIG. 33. This interface also allows further filtering of the report contents (3302). For example, the GPO may print a report of all bids and associated ranking, or it may print a report on all items that were deleted or excluded.

GPO—Award Bid

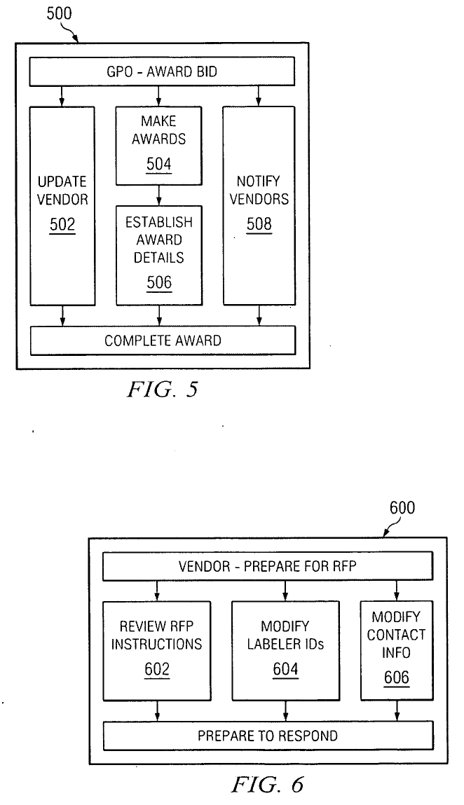

Once bids are ranked and accepted, they are ready to be awarded to the respective vendors. FIG. 5 presents a flow diagram representing the major function steps provided by the system to facilitate this action. First, any updates to the vendor information are applied (502). Next, the awards are made (504) and award details are established (506). Once complete, the vendors are notified of the award (508).

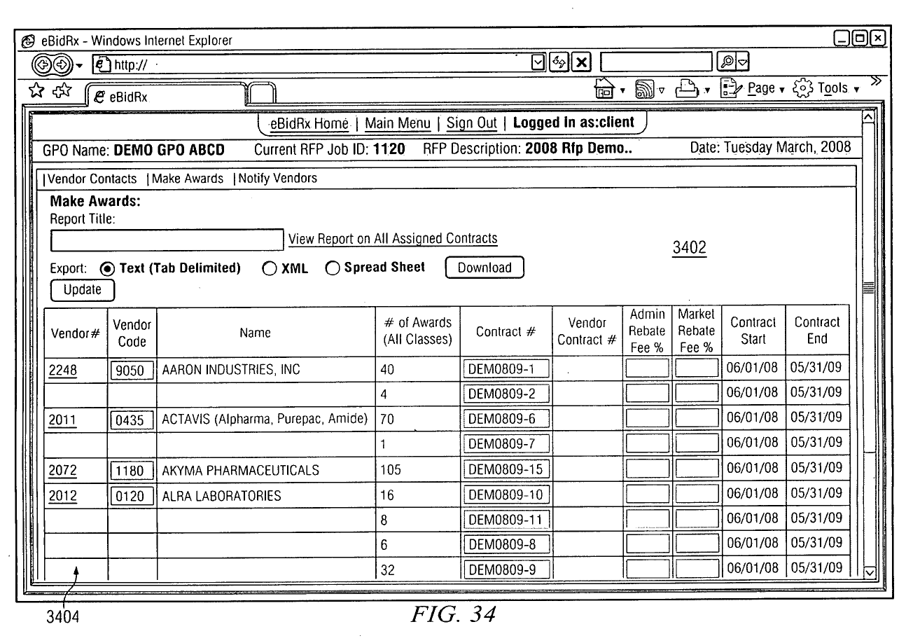

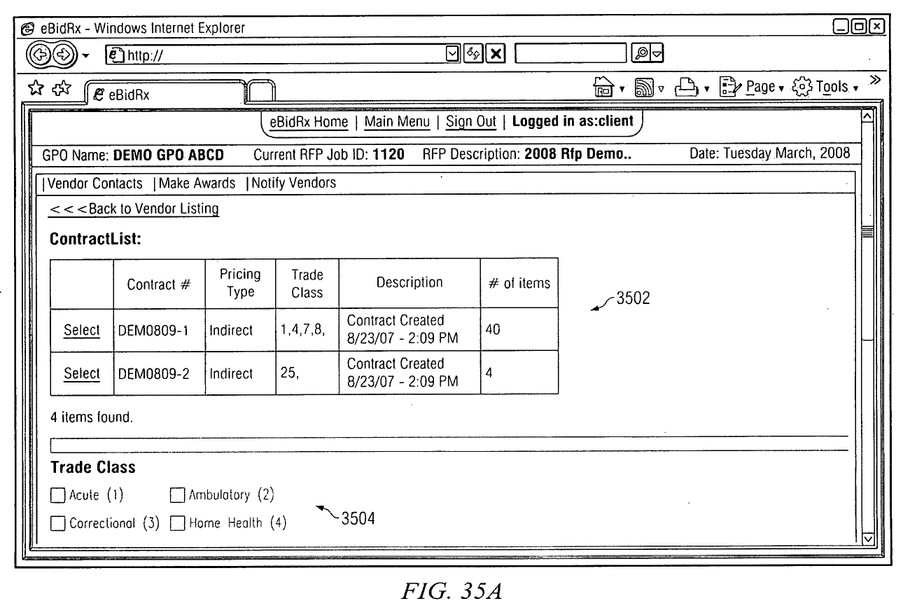

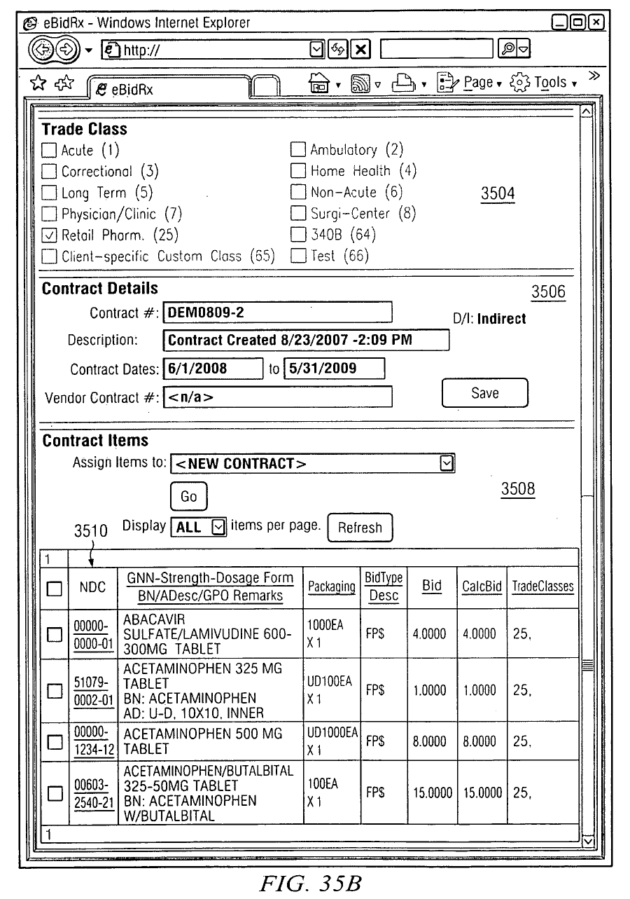

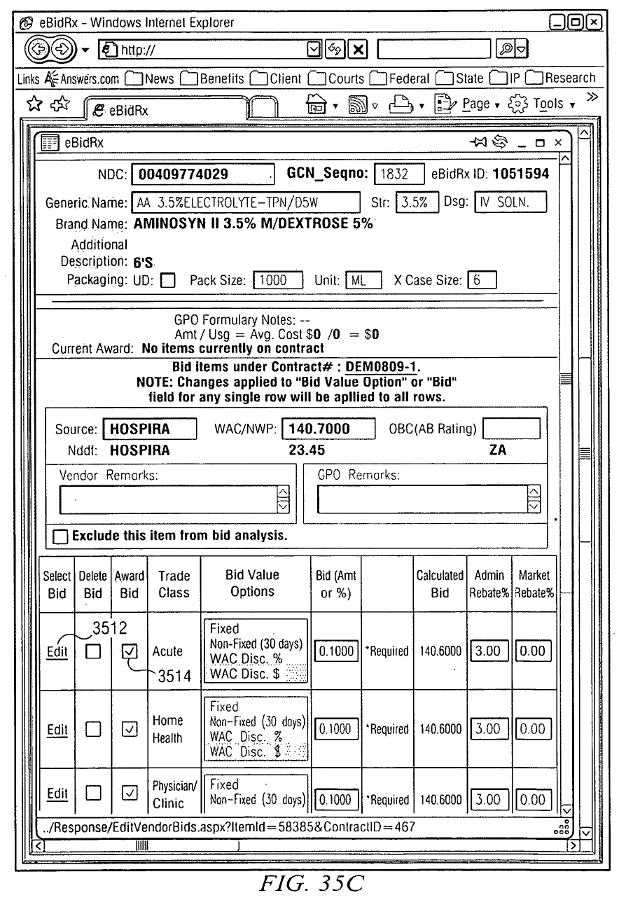

To begin, if new vendors have been added the system allows the GPO to update the vendor's address and related data (502). Once the vendors are updated, the system allows the GPO to make awards (504). FIG. 34 presents an interface as supplied by the system to facilitate this action. The interface displays the list of vendors for the RFP (3402) with goods that the GPO has accepted. This interface further allows modification of a Vendor Code, the Contract Description, and any Rebate Fee percentages. Selecting the Vendor number link (3404) presents the GPO with an interface such as that in FIG. 35, providing greater detail of the products and contracts of the given vendor.

As shown in FIG. 35A details concerning the contracts currently assigned to the particular vendor are displayed (3502). FIG. 35B displays the remainder of the interface, highlighting the trade classes (3504), contract details (3506) and contract items (3508). Certain contract details (3506) may be manipulated (Contract #, Description, dates, and unique Vendor Contract #. Last minute changes to the contract items (3508) may also be made by selecting the NDC (351(0) of the desired item.

When an NDC code (3510) for a particular item is selected; the GPO is presented with an interlace such as that in FIG. 35C. From this interface, the GPO may make modifications to the individual items. To edit an item, the EDIT link (3512) is selected. This makes available the Delete Bid, Award Bid, Bid Value Options, Bid, and Rebate fields. To award a bid, the Award Bid checkbox is selected (3514). Conversely, to reject an item the box is cleared. To delete the item entirely, the Delete Bid checkbox is selected. Changes are committed to the contract when the “Save” button or link is selected.

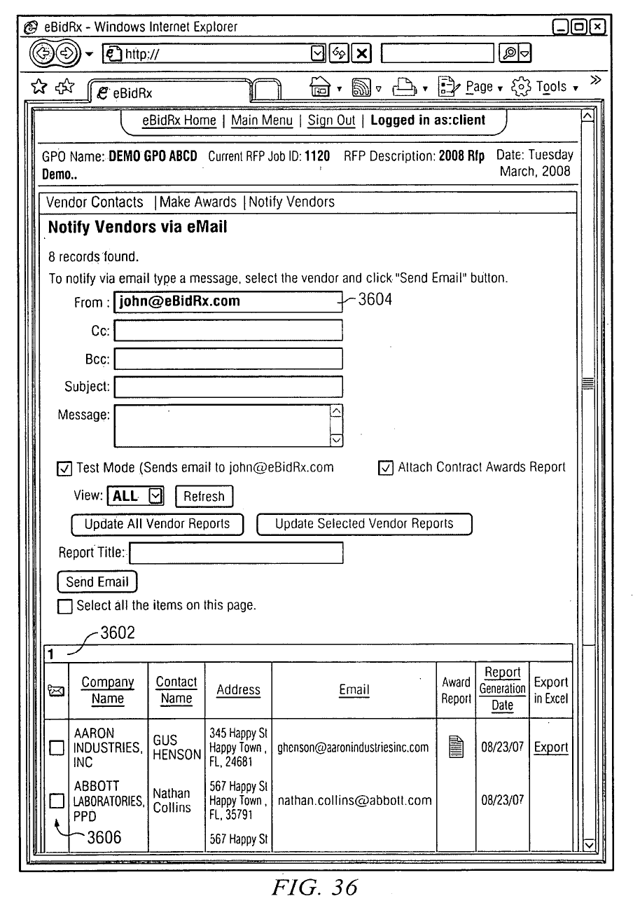

Referring again to FIG. 5, once all bid proposals are processed the vendors may be notified (508). FIG. 36 presents an interface as supplied by the system to facilitate notification of the awards. A list of vendors with awarded bid proposals is shown (3602). To send a vendor a notification message, the appropriate checkbox is selected (3606). The GPO may also add an additional message to each vendor (3604) prior to sending the email message.

Vendor—Awarded Bid Response

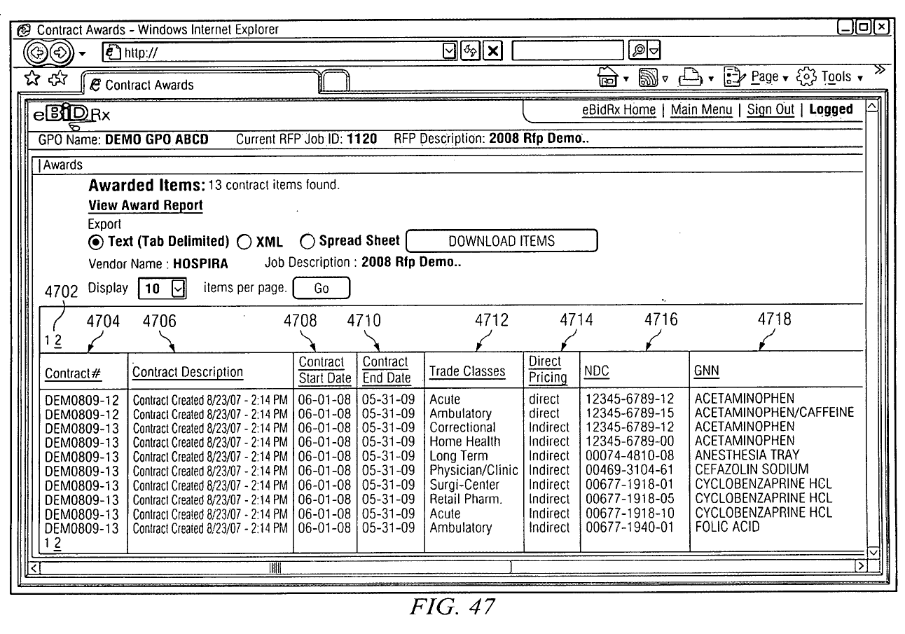

Referring again to FIG. 2, when the vendor receives an award notification, the system may be accessed to review the award details (204). To review the awards, the system provides the vendor an interface such as that depicted in FIG. 47. From this interface, the vendor may review general details of each contract (4702). For example, a list of all contracts awarded the vendor is presented along with the following information: contract number (4704), contract description (4706), contract start date (4708), contract end date (4710, Trade Classes (4712), direct pricing (4714), NDC (4716), generic name (4718), Brand Name, Strength, Dosage, Add. Desc., Packaging, Bid, Bid Type, Calc Bid, WAC, Vendor Remarks, Proposal ID, and Source. Upon receiving the award, it is up to the vendor to honor the negotiated price for all GPO members. Fulfillment of orders occurs outside the process of the present invention.

Drug Catalog

Another integral part of the system of the present invention is the online drug catalog. The system uploads data from National Drug Data File® (NDDF®) to maintain current data. FIG. 8 depicts a flow diagram indicating the drug database search capabilities (800) as provided in an embodiment of the present invention. The drug database may be searched for drug entries by Vendor (802), Drug Name (804), NDC (806), or AHFS number (808). National Drug Data File® and NDDF® are registered trademarks of First DataBank, Inc. First DataBank is the private industry source for the NDDF database.

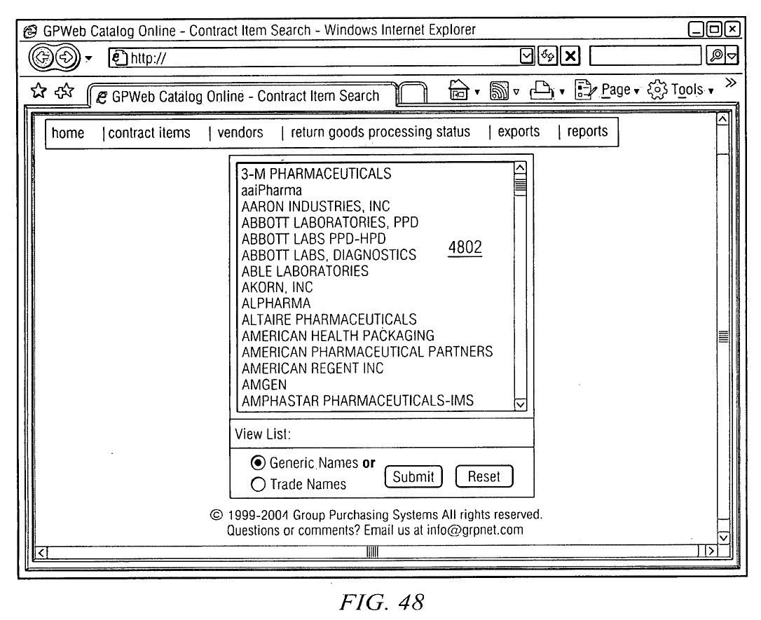

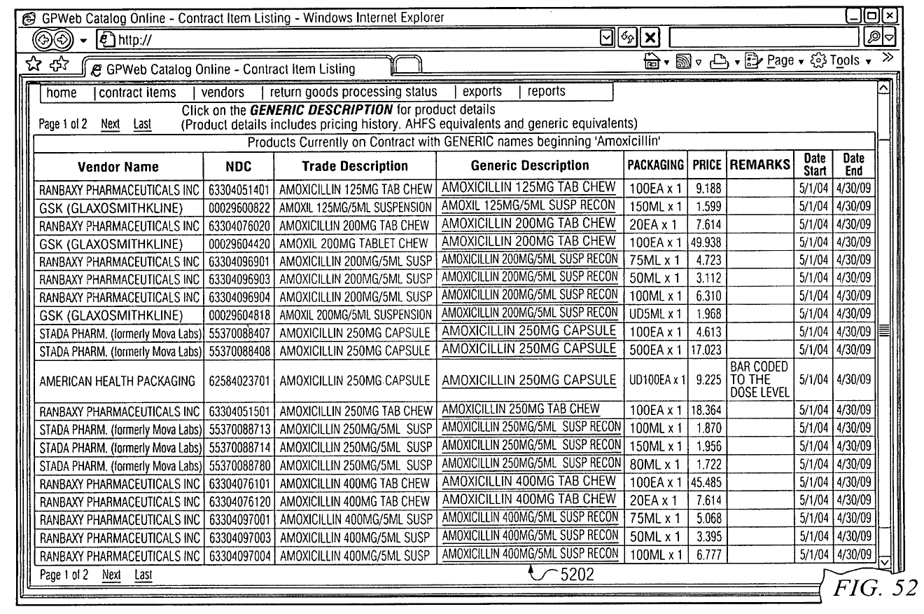

FIG. 48 presents an interface as provided by the present system to allow a GPO to search for drug database entries based on the vendor name (4802). When the GPO selects the desired vendor name (4802), a list of the pharmaceuticals that the vendor provides under contract to the GPO is provided in an interface such as that shown in FIG. 52.

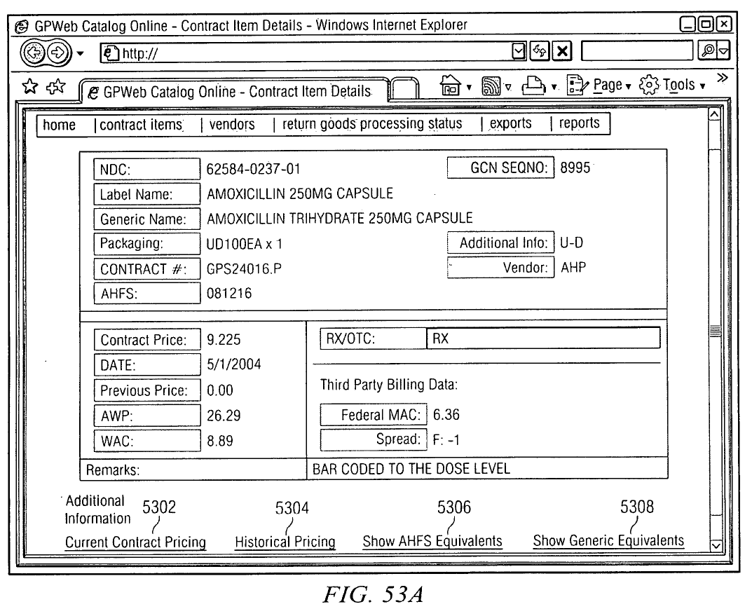

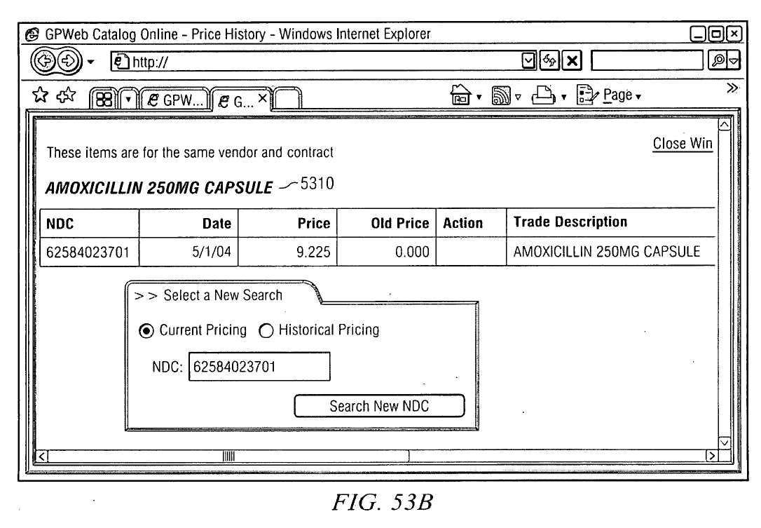

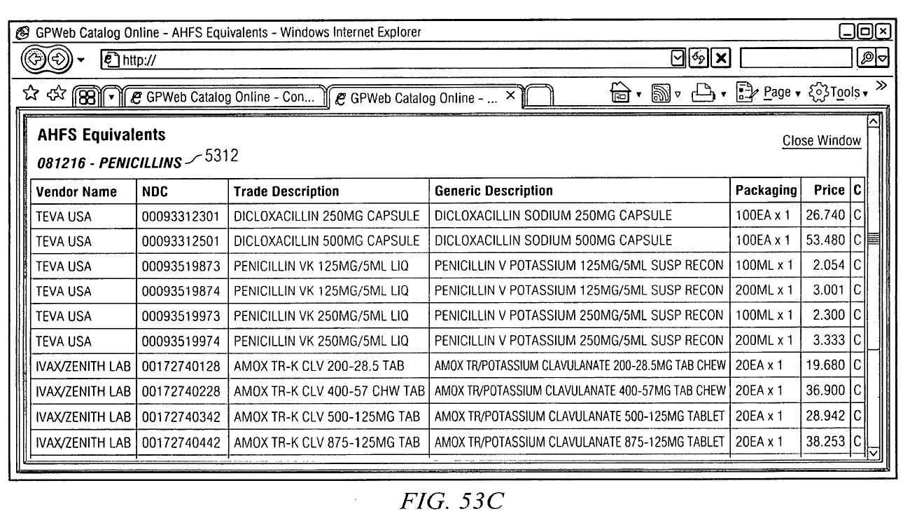

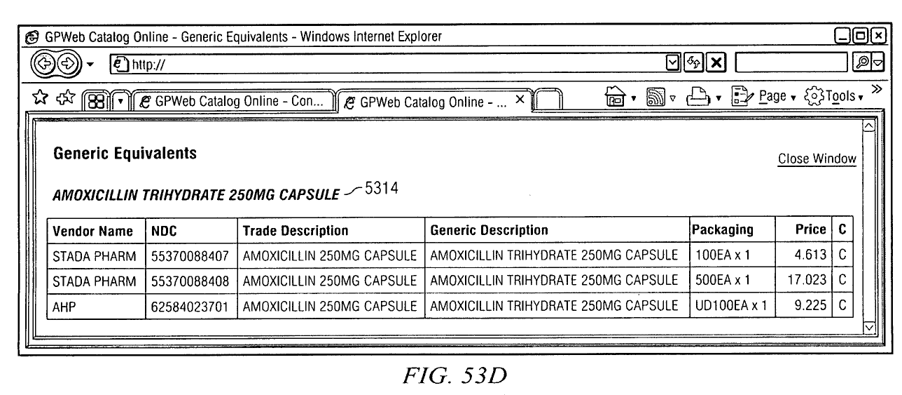

Clicking on a pharmaceutical's name (5202) on this list brings up yet another interface, such as that shown in FIG. 53A, providing greater detail about the particular drug. The details include contract information such as: NDC, Trade Name, Generic Name, Packaging, Contract Number, AHFS number, GCN Sequence number, Vendor Name, Contract Price, Date, Previous Price, AWP, WAC, RX/OTC, Federal MAC, and Spread. At the bottom of the detail interface, the GPO can view further detail regarding the drug such as Current Contract Pricing (5302), Historical Pricing (5304), AHFS Equivalents (5306), and Generic Equivalents (5308).

Referring again to FIG. 53A, selecting Current Contract Pricing (5302) brings up an interface such as that shown in FIG. 53A. This interface displays current contract pricing data for the particular drug of interest. Selecting Historical Pricing (5304) brings up an interface such as that shown in FIG. 53B. This interface displays the historical contract pricing for the particular drug (5310).

Referring again to FIG. 53A, selecting AHFS Equivalents (5306) brings up an interface such as that shown in FIG. 53C. This interface displays details for all AHFS equivalents for the particular drug (5312), detailing the vendor's name, NDC, trade and generic description, packaging, and price for each equivalent.

Referring again to FIG. 53A, selecting Generic Equivalents (5308) brings up an interface such as that shown in FIG. 53D. This interface displays details for all generic equivalents for the particular drug (5314), detailing the vendor's name, NDC, trade and generic description, packaging, and price for each equivalent.

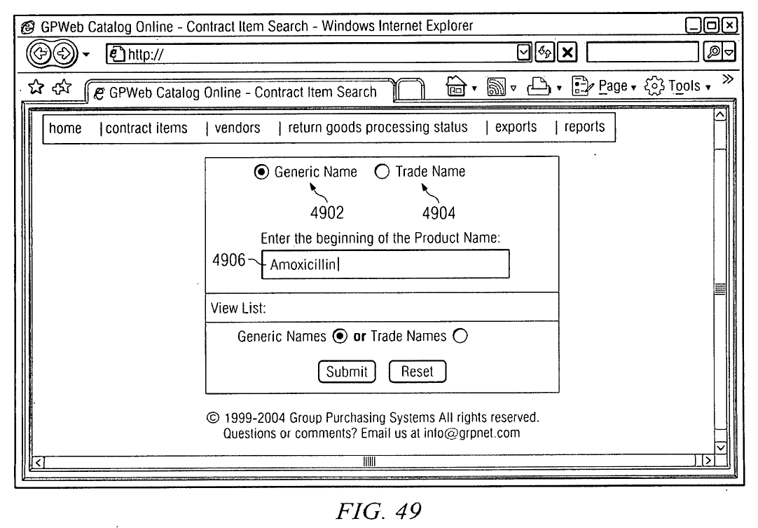

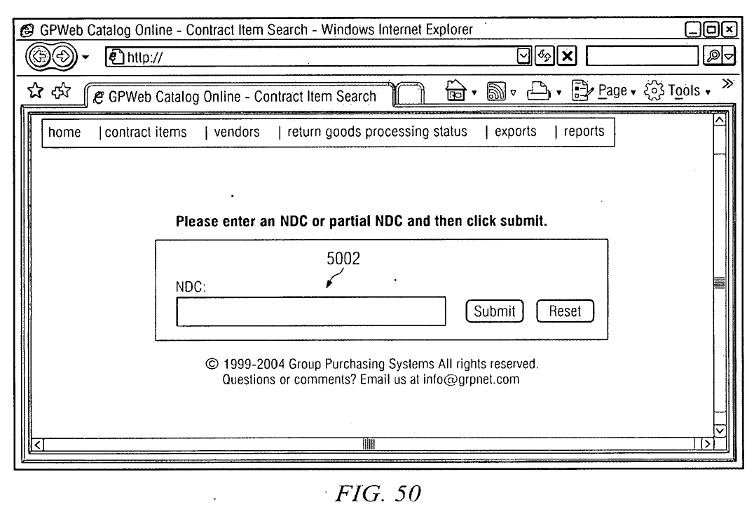

FIG. 49 presents an interface as provided by the present system to allow the GPO to search for drug database entries based on a generic name (4902), trade name (4904), or some portion thereof (4906). The GPO need only enter a name or a portion of a name (4906) to return a display of drugs in the drug database that match. The system returns a listing of all drugs currently under contract with a name that matches the search term. FIG. 52 presents a display of a list of the drugs returned by a search for the generic name, “AMOX.” Selecting the name of one of the results (5202) brings up the interface as shown in FIG. 53A, displaying further details as described above.

FIG. 50 presents an interface as provided by the present system to allow a user to search for drug database entries based on an NDC code or some portion thereof (5002). The GPO need only enter an NDC code or a partial NDC code and the system will return a listing of all drugs currently available under contract that matches the search term. If the user inputs an exact NDC, only a single drug matching that number is displayed in a format similar to the interface'shown in FIG. 52. Likewise, a partial NDC may return no entries, one entry, or multiple entries arranged as in FIG. 52. Selecting the name of one of the results (5202) brings up the interface as shown in FIG. 53A and described above.

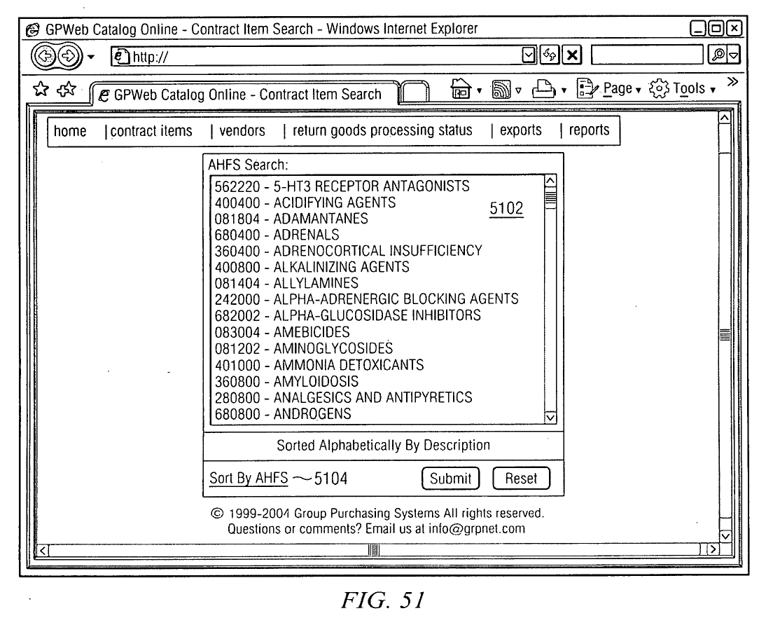

FIG. 51 presents an interface as provided by the present system to allow a user to search for drug database-entries based on the AHFS description (5102). The GPO need only select a drug from this interface based on description or AHFS number. The entries may be sorted by AHFS or by description (5104). Selecting a particular entry presents the GPO with a display of the related drugs such as that shown in FIG. 52. The number of entries varies for each AHFS. Further selecting the name of one of the displayed drugs (5202) provides the user more detail such as that shown in FIG. 53A and described above.

Contract Management

FIG. 9 depicts a flow diagram of the contract management features (900) in the present embodiment. With this feature, the GPO has the ability to view and maintain awarded contract data on a vendor-by-vendor basis (902), an item-by-item basis (904), and an all products basis (906).

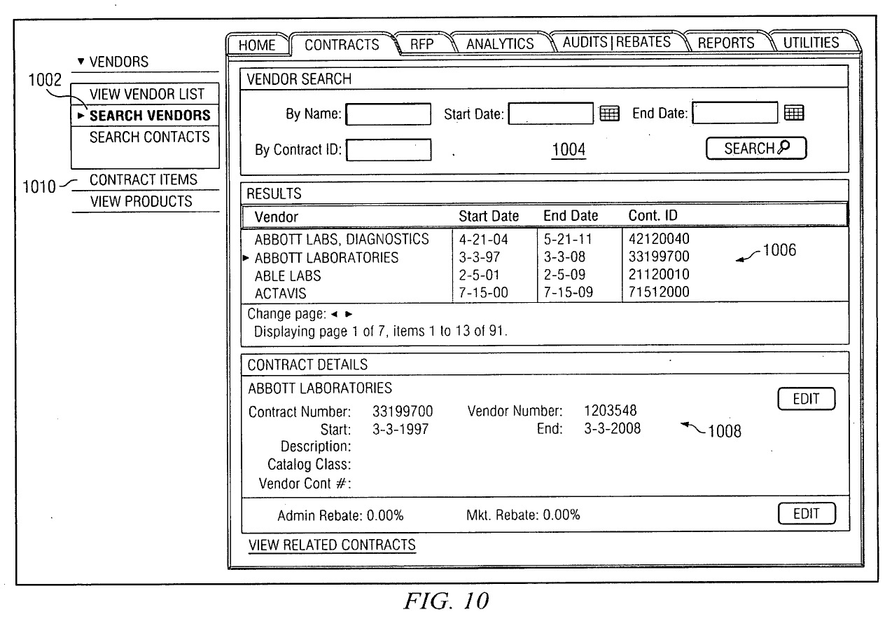

Selecting the contracts feature (904) brings up an interface such as that shown in FIG. 10. Further selecting the search “Vendors” link (1002) presents an interface that allows a GPO to view and manage awarded contracts on a vendor-by-vendor basis. At the top of the interface is a group of text boxes that allow the user to view and modify the vendor/manufacturer name, contract numbers, contract start or end date, or contract ID to search for (1004). Further details include an assigned description, the class of trade that applies to the contract, an assigned contract number, and administrative and marketing rebate fees on the contract. After selecting the “Search” button or link, the results appear in the interface (1006).

The vendor search results display the current vendor names, start and end dates, and contract ID of current and past contracts that satisfy the provided search criteria. Selecting one of the displayed vendor rows provides further details of the contract in the space beneath (1008). These details may be edited by selecting the “Edit” button or link. Editable fields include the contract start and end dates, contract description, catalog class, and vendor contact number. Admin rebate and market rebate percentages are provided on a separate line and are separately editable as well.

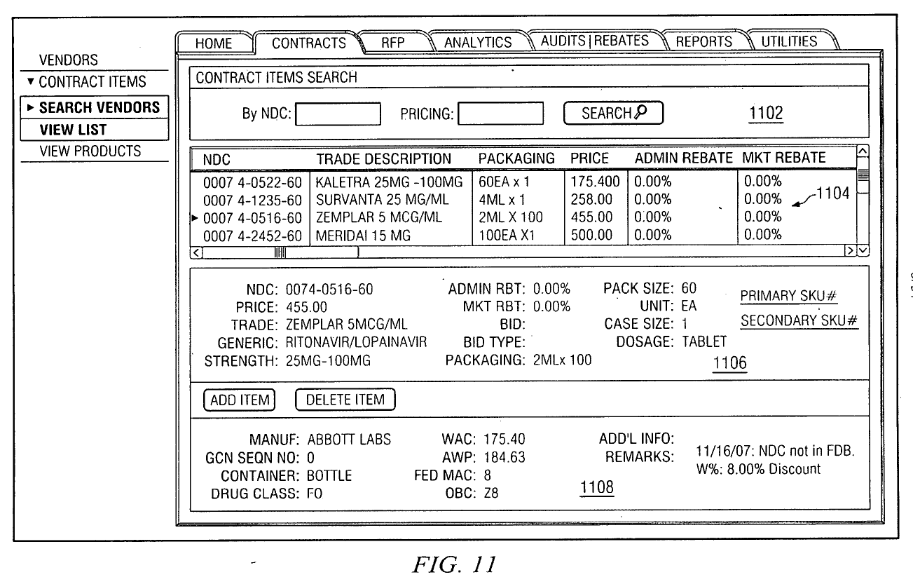

From the contracts feature, selecting the “Contracts” link (1010) presents an interface such as that shown in FIG. 11. This interface allows a GPO to view and manage awarded contracts on an item-by-item basis. The top of the interface provides text boxes to input NDC code of an item to search for (1102). Once the “Search” button or link is selected, the results appear in the space below (1104).

The item search results display the current NDC, trade description, pricing, admin rebate, market rebate, and other related data. Selecting a particular displayed item row brings up additional detailed data in the space beneath (1106). The additional displayed data (1108) includes details such as National Drug Code, contract price, trade description (for example, Tylenol), generic description (for example, Ibuprofen), drug strength, packaging size of the contract item, item level Admin/Mkt Rebate discount, bid and bid type submitted by the vendor (ex. 5% off WAC), drug manufacturer name, GCN sequence number (as defined by First DataBank), container type, code assigned by First DataBank, pricing values as defined by First DataBank, Orange Book Code, or AB Rating, as assigned by the Food and Drug Administration (FDA), additional info as defined by First DataBank, and any GPO remarks.

Contract item details are also editable. Selection of the Edit Item button allows all data fields in sections (1106) and (1108) to be available for editing. The history of any contract changes is maintained by the system to support accurate auditing.

Auditing

In the present embodiment, the auditing functionality allows a GPO to monitor its sales activity to verify that is paying the correct price for contracted items. The audit may be run manually by accessing the interface as previously described, or may be run automatically at regularly scheduled times.

The audit produces an exceptions report, in spreadsheet format, that can be submitted directly to their wholesaler. This exceptions report includes problems such as incorrect pricing for contracted items. With the upload of sales data and credit and re-bill information, the exceptions can be track until resolution. Once the audit has been resolved it can then be closed out.

In the embodiment audits may be run for multiple wholesalers simultaneously. The system provides the appropriate exceptions report for each wholesaler as each wholesaler may require different information. Automated audits generate a user notification via email when the audit has completed.

The embodiment provides reporting functionality that allows a GPO to review its purchasing and make effective decisions to improve the “bottom line.” As with the auditing functionality, such reports may be manually generated or scheduled to run automatically at pre-established times.

The reports generated by the embodiment cover items such as sales data, contracts, vendors, membership, wholesaler, GPO, users, audits and rebates. Customized reports and ad hoc reports are also available. The available reports include:
Sales Data Reports (which includes Items On/Off Contract, Purchases by Manufacturer, Detail Purchases by Manufacturer, Facility Purchases, Facility Detail Purchases, Wholesaler Purchases and Detail Wholesaler Purchases);
Contract Reports (which includes Contract, Contract Items, Contract Items by Contract, Contracts by Vendor, Contracts by GPO, Contract Awards and Pending Contract Awards);
Member Reports (which includes Member List, Member Contacts, Member Logins, Members by Role);
Wholesaler and GPO Reports (which includes Wholesaler/GPO List, Wholesaler/GPO Contacts);
User Reports (which includes User List, User Logins, User Login by Member, User Login by State, and User Login by Facility);
Audit Reports (which includes Audit Recap, Audit Recap Detail, and Audit Recap by Member); and
Rebate Reports (which includes Rebates by Vendor, Rebates by Member, Rebates by GPO and Rebates by Drug).

Although the detailed description presented the flow of the RFP/bid process in a sequential manner, not all of the steps need be practiced as such. Further, not all functionality described applies to each and every RFP. For example, some RFPs may not require an update to the formulary. In another example, a GPO may need to revisit the Configure RFP functionality to adjust dates after having uploaded documents to the system. Further still, some steps may need to be performed repeatedly until all data is input in a satisfactory fashion.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise. (58,266).

We claim:

1. A network based pharmaceutical goods bid analysis, bid award, and contract management method for utilization by users belonging to predefined classes, wherein at least one first user is a member of a first class that seeks to obtain pharmaceuticals or non-pharmaceutical hospital or surgical center goods and at least one second user is a member of a second class that seeks to supply the sought after goods, the method steps comprising:
providing at least one user interface, wherein the interface presents functionality specific to a user's class;
accepting, via the at least one user interface, a request for proposal (RFP) of at least one good from the first user;
accepting, via the at least one user interface, one or more bids from at least one second user in response to the RFP;
allowing the first user, via the at least one user interface, to review and either accept or reject each bid and to enter into a contract with the accepted bid's respective second user;
allowing the first and second users, via the at least one user interface, to independently view and manipulate at least a portion of the contract; and
providing access to an integrated drug catalog, via the at least one user interface, to assist in RFP creation and contract management.

2. The method of claim 1 further comprising:
providing access to an integrated formulary to assist in RFP creation and contract management.

3. The method of claim 2 wherein the formulary may be updated by the first user's usage data or previous contract data.

4. The method of claim 1 further comprising:
providing notification to the at least one second user of a pending RFP.

5. The method of claim 4 wherein the notification is by an automatically generated email or letter.

6. The method of claim 1 further comprising:
assigning at least one penalty to at least a portion of the RFP to affect bid ranking.

7. The method of claim 6 wherein the penalty is chosen from the group consisting of WAC Discount, Fixed Pricing, Non-Fixed Pricing Admin Fee Rebate, and Market Fee Rebate.

8. The method of claim 6 wherein the penalty is applied automatically to allow for automatic ranking and acceptance of bids without review by the first user.

9. The method of claim 1 further comprising:
assigning at least one trade class to the RFP.

10. The method of claim 1 further comprising:
uploading externally generated contract data, wherein the uploaded contract may be subsequently managed.

11. The method of claim 1 wherein the drug catalog is searchable by criteria chosen from the group consisting of vendor name, drug name, NDC, and AHFS.

12. The method of claim 1 wherein the drug catalog is updated using the National Drug Code directory.

13. A network based pharmaceutical goods bid analysis, bid award, and contract management system for utilization by users belonging to predefined classes, wherein at least one first user is a member of a first class that seeks to obtain pharmaceuticals or non-pharmaceutical hospital or surgical center goods and at least one second user is a member of a second class that seeks to supply the sought after goods, the system comprising:
a computer processing device, the computer processing device being accessible by the users over a network, the processing device comprising:
a database storage device; and
a computer readable medium including machine-readable program instruction code capable of performing the programming steps comprising:
providing at least one user interface, wherein the interface presents functionality specific to a user's class;
accepting, via the at least one user interface, a request for proposal (RFP) of at least one good from the first user;
accepting, via the at least one user interface, one or more bids from at least one second user in response to the RFP;
allowing the first user, via the at least one user interface, to review and either accept or reject each bid and to enter into a contract with the accepted bid's respective second user;
allowing the first and second users, via the at least one user interface, to independently view and manipulate at least a portion of the contract; and
providing access to an integrated drug catalog, via the at least one user interface, to assist in RFP creation and contract management.

14. The system of claim 13, the programming steps further comprising:
providing access to an integrated formulary to assist in RFP creation and contract management.

15. The system of claim 14 wherein the formulary may be updated by the first user's usage data or previous contract data.

16. The system of claim 13, the programming steps further comprising:
providing notification to the at least one second user of a pending RFP.

17. The system of claim 16 wherein the notification is by an automatically generated email or letter.

18. The system of claim 13, the programming steps further comprising:
assigning at least one penalty to at least a portion of the RFP to affect bid ranking.

19. The system of claim 18 wherein the penalty is chosen from the group consisting of WAC Discount, Fixed Pricing, Non-Fixed Pricing, Admin Fee Rebate, and Market Fee Rebate.

20. The system of claim 18 wherein the penalty is applied automatically to allow for automatic ranking and acceptance of bids without review by the first user.

21. The system of claim 13, the programming steps further comprising:
assigning at least one trade class to the RFP.

22. The system of claim 13, the programming steps further comprising:
uploading externally generated contract data, wherein the uploaded contract may be subsequently managed.

23. The system of claim 13 wherein the drug catalog is searchable by criteria chosen from the group consisting of vendor name, drug name, NDC, and AHFS.

24. The system of claim 13 wherein the drug catalog is updated using the National Drug Code directory.

25. A computer software program tangibly embodied in a computer readable medium, the program including machine-readable instructions executable by a computer processor for performing a network based pharmaceutical goods bid analysis, bid award, and contract management method for utilization by users belonging to predefined classes, wherein at least one first user is a member of a first class that seeks to obtain pharmaceuticals or non-pharmaceutical hospital or surgical center goods and at least one second user is a member of a second class that seeks to supply the sought after goods, the programming steps comprising:
providing at least one user interface, wherein the interface presents functionality specific to a user's class;
accepting, via the at least one user interface, a request for proposal (RFP) of at least one good from the first user;
accepting, via the at least one user interface, one or more bids from at least one second user in response to the RFP;
allowing the first user, via the at least one user interface, to review and either accept or reject each bid and to enter into a contract with the accepted bid's respective second user;
allowing the first and second users, via the at least one user interface, to independently view and manipulate at least a portion of the contract; and
providing access to an integrated drug catalog, via the at least one user interface, to assist in RFP creation and contract management.

26. The computer software program of claim 25, the programming steps further comprising:
providing access to an integrated formulary to assist in RFP creation and contract management.

27. The computer-software program of claim 26 wherein the formulary may be updated by the first user's usage data or previous contract data.

28. The computer software program of claim 25, the programming steps further comprising:
providing notification to the at least one second user of a pending RFP.

29. The computer software program of claim 28 wherein the notification is by an automatically generated email or letter.

30. The computer software program of claim 25, the programming steps further comprising:
assigning at least one penalty to at least a portion of the RFP to affect bid ranking.

31. The computer software program of claim 30 wherein the penalty is chosen from the group consisting of WAC Discount, Fixed Pricing, Non-Fixed Pricing, Admin Fee Rebate, and Market Fee Rebate.

32. The computer software program of claim 30 wherein the penalty is applied automatically to allow for automatic ranking and acceptance of bids without review by the first user.

33. The computer software program of claim 25, the programming steps further comprising:
assigning at least one trade class to the RFP.

34. The computer software program of claim 25, the programming steps further comprising:
uploading externally generated contract data, wherein the uploaded contract may be subsequently managed.

35. The computer software program of claim 25 wherein the drug catalog is searchable by criteria chosen from the group consisting of vendor name, drug name, NDC, and AHFS.

36. The computer software program of claim 25 wherein the drug catalog is updated using the National Drug Code directory.
